(19) United States
(12) Patent Application Publication
(10) Pub. No.: US 2006/0075867 A1
(43) Pub. Date: Apr. 13, 2006

(54) Laser apparatus

(76) Inventors: Mark A. Etter, Humboldt, TN (US); Jaime Garcia, Jackson, TN (US); Kathy DeKeyser, Jackson, TN (US); Alan Phillips, Jackson, TN (US); Robert F. Burkholder, Jackson, TN (US); Jeffrey Weston, Jackson, TN (US); Melinda J. Hearn, Jackson, TN (US)

Correspondence Address: SUITER WEST SWANTZ PC LLO, 14301 FNB PARKWAY, SUITE 220, OMAHA, NE, 68154, US

(21) Appl. No.: 10/445,290

(22) Filed: May 21, 2003

Related U.S. Application Data
(60) Provisional application No. 60/429,840, filed on Nov. 27, 2002.

(51) Int. Cl. B26D 7/27

(52) U.S. Cl. 83/522.11

(57) ABSTRACT

A table saw allows a user to operate the table saw through a graphical user interface communicatively coupled with a non-contact measurement and alignment device. The graphical user interface correlates user engageable selectors with a logically related menu of table saw setting options displayed on a display screen in a high quality and easily readable format. The non-contact measurement and alignment device uses one or more lasers to determine table saw settings and establish proper alignment based on user needs.

### CROSS REFERENCE TO RELATED APPLICATION

The present application claims priority under 35 U.S.C. 119 to U.S. Provisional Application Ser. No. 60/429,840, filed on Nov. 27, 2002, and U.S. application Ser. No. 10/413,455, filed on Apr. 14, 2003. Both the U.S. Provisional Application Ser. No. 60/429,840 and the U.S. application Ser. No. 10/413,455 are herein incorporated by reference in their entireties.

### FIELD OF THE INVENTION

The present invention generally relates to the field of power tools, and particularly to a laser apparatus for use with a variety of power tools, such as table saws, belt sanders, lathes, disc sanders, planers, wood shapers, boring machines, jointers, drill presses, and the like.

### BACKGROUND OF THE INVENTION

Power tools are used to accomplish a variety of tasks. No matter the task, the production of accurate and precise work is a high priority. Further, being able to reproduce the exact work is another necessary feature. Unfortunately, the precision and accuracy of work performed on these power tools is limited by human error. Further, the reproducibility of duplicate work pieces is also hampered by the same human error.

Many power tools today have incorporated guidance mechanisms into the power tool assembly. These mechanisms assist an operator in stabilizing the work piece as the power tool executes a function upon it. However, the operator is still required to establish the location of the mechanism. This may result in imprecise and inaccurate work piece production due to imprecise measurements and settings established by the operator. Further, it is often necessary to perform different functions and then return to previous settings. Consequently, the operator is forced to establish and then re-establish settings, which may lead to further imprecision and inaccuracy in the work product produced due to operator error.

Therefore, it would be desirable to provide an apparatus that enables a power tool operator to establish and, if necessary, re-establish precise and accurate measurements and settings for the power tool in order to ensure work product of a high quality.

### BRIEF DESCRIPTION OF THE DRAWINGS

The numerous advantages of the present invention may be better understood by those skilled in the art by reference to the accompanying figures in which:

FIG. 1 is an illustration of a laser apparatus including a computing system in accordance with an exemplary embodiment of the present invention;

FIG. 2 is an illustration of the laser apparatus showing alternative power supply embodiments;

FIGS. 3 and 4 illustrate the computing system shown in FIG. 1, including display screens;

FIG. 5 is an illustration of the computing system showing alternative power supply embodiments;

FIG. 6 is an illustration of the laser apparatus coupled to a leveling assembly in accordance with an exemplary embodiment of the present invention;

FIG. 7 is an illustration of a laser apparatus coupled to a level assembly and in communication with a remote computing system;

FIG. 8 is an isometric illustration of a table saw system including the laser apparatus shown in FIG. 1 coupled to a fence connected to a table saw emitting three laser beams;

FIG. 9 is a top plan view of the table saw system of FIG. 8 illustrating the laser apparatus emitting three laser beams for establishing distance measurements in accordance with an exemplary embodiment of the present invention;

FIG. 10 is a side elevation view of the table saw system of FIG. 8 illustrating the laser apparatus emitting a single laser beam for establishing a distance measurement;

FIG. 11 is an illustration of the laser apparatus coupled with a combination belt sander and disc sander power tool;

FIG. 12 is an illustration of the laser apparatus coupled with a lathe;

FIG. 13 is an illustration of a laser light indicia and reading assembly coupled with a computing system in accordance with an exemplary embodiment of the present invention;

FIG. 14 is an illustration of the laser light indicia and reading assembly coupled to a level assembly, the computing system being coupled to the level assembly and in communication with the laser scanning apparatus;

FIGS. 15A, 15B, and 15C illustrate a known scanning module which may be employed in the laser light indicia and reading assembly in accordance with an exemplary embodiment of the present invention;

FIG. 16 is a top plan view of a known scanning module employing a dithering assembly;

FIG. 17 is an illustration of a known dithering assembly employing a drive coil and drive magnet to provide mirror oscillation;

FIG. 18 is an illustration of a known dithering assembly employing travel stops to control the range of rotational travel imparted to the mirror;

FIG. 19 is an illustration of a known dithering assembly employing pads connected to drive and feedback magnets to control the range of rotational travel imparted to the mirror;

FIG. 20 is an illustration of the laser light indicia and reading assembly coupled with a table saw and establishing a laser light cut line;

FIG. 21 is an illustration of the laser light indicia and reading assembly coupled with the table saw and establishing a laser light cut line on a work piece;

FIG. 22 is an illustration of the laser light indicia and reading assembly coupled with a belt sander and establishing a laser beam line;

FIG. 23 is an illustration of the laser light indicia and reading assembly coupled with the belt sander and establishing a laser beam line on a work piece;

FIG. 24 is an illustration of the laser light indicia and reading assembly coupled with a wood shaper and establishing a laser beam line;

FIG. 25 is a flowchart illustrating functional steps which are accomplished by the laser apparatus and the laser light indicia and reading assembly of the present invention;

FIG. 26 is an illustration of a laser apparatus connected to a fence on a table saw, whereupon each laser source includes a dithering assembly;

FIG. 27 is an illustration of multiple laser light indicia and reading assemblies connected to a table saw emitting a laser beam grid produced by laser sources with dithering assemblies;

FIG. 28 is an illustration of a laser light indicia and reading assembly connected to a drill press establishing multiple laser beam drill points in a horizontal plane;

FIG. 29 is an illustration of a laser light indicia and reading assembly establishing multiple laser beam drill points in a vertical plane;

FIG. 30 is an isometric illustration of a rotating laser apparatus including a computing system and rotation assembly in accordance with an exemplary embodiment of the present invention;

FIG. 31 is an illustration of the rotating laser apparatus including a display menu and an angle measurement device;

FIGS. 32 and 33 illustrate the rotation assembly including the angle of measurement device and a lock and release unit operable by the user;

FIG. 34 is an illustration of the rotating laser apparatus in operation;

FIG. 35 is an illustration of the rotating laser apparatus with laser beams produced by laser sources with dithering assemblies;

FIGS. 36 and 37 are illustrations of a computing system of the laser apparatus showing display menus available;

FIG. 38 is a flowchart illustrating functional steps which are accomplished by the rotating laser apparatus;

FIG. 39 is an illustration of a laser apparatus with a single laser source providing a laser beam which is split to emit separate laser beams from the laser beam source assemblies located within the housing by optical splitters;

FIG. 40 is an illustration of the laser apparatus coupled with a computing system that provides a single laser beam which is split to emit separate laser beams from the laser beam source assemblies located within the housing by optical splitters;

FIG. 41 is an illustration of a rotating laser apparatus with a single laser source;

FIG. 42 is an illustration of a rotating laser apparatus with a first and a second laser source;

FIG. 43 is an illustration of the laser apparatus in FIG. 39, including a plurality of photo multipliers disposed within a housing of the laser apparatus;

FIG. 44 is an illustration of a laser apparatus including a leveling mechanism in accordance with an exemplary embodiment of the present invention;

FIG. 45 is an illustration of a plurality of the laser apparatus, shown in FIG. 44, coupled with one another;

FIG. 46 is an illustration of the laser apparatus in FIG. 44, providing leveling readings to a drop ceiling assembly; and

FIG. 47 is a diagrammatic illustration of an exemplary graphical-user-interface for use with embodiments of the present invention, wherein (a) blade-to-fence distance; (b) blade bevel; and (c) blade height, are illustrated on a single interface screen;

FIG. 48 is a diagrammatic illustration of an exemplary graphical-user-interface for use with embodiments of the present invention;

FIG. 49 is a diagrammatic illustration of an exemplary graphical-user-interface for use with embodiments of the present invention;

FIG. 50 is a diagrammatic illustration of an exemplary graphical-user-interface for use with embodiments of the present invention;

FIG. 51 is a diagrammatic illustration of an exemplary graphical-user-interface for use with embodiments of the present invention

FIG. 52 is a diagrammatic illustration of an exemplary graphical-user-interface for use with embodiments of the present invention

FIG. 53 is a diagrammatic illustration of an exemplary graphical-user-interface for use with embodiments of the present invention

### DETAILED DESCRIPTION OF THE INVENTION

Reference will now be made in detail to the presently preferred embodiments of the invention, examples of which are illustrated in the accompanying drawings.

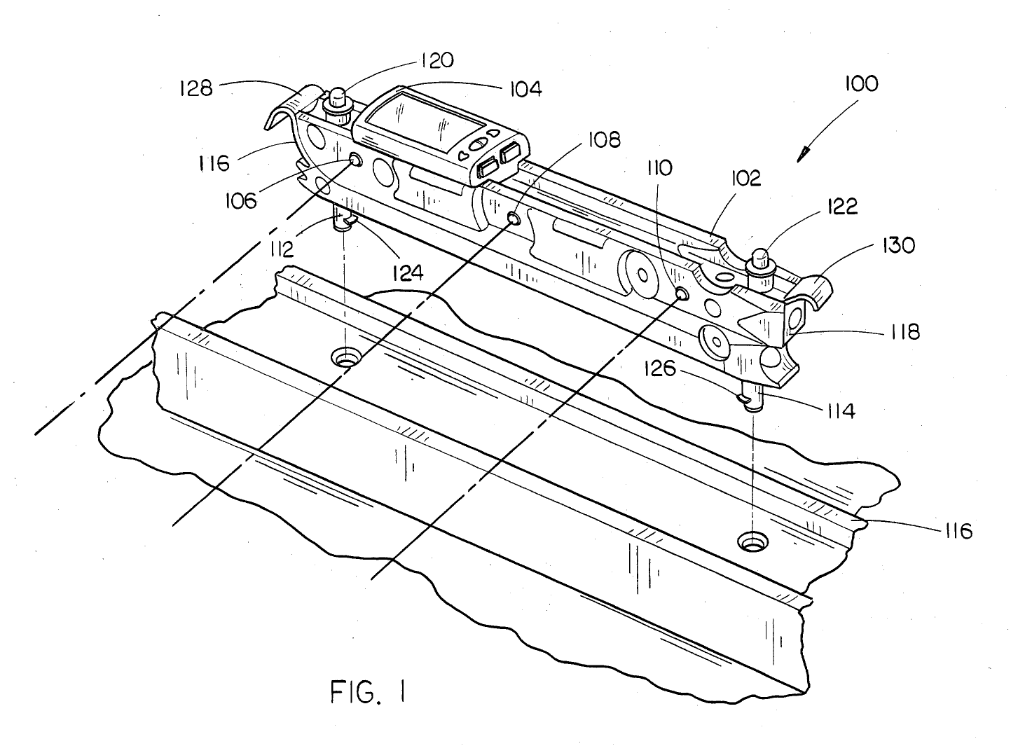

Referring generally now to FIG. 1, a laser apparatus 100 of the present invention is shown. In the present embodiment, the laser apparatus 100 comprises a housing 102 coupled with a computing system 104. Further, the housing 102 is disposed with a first laser source 106, a second laser source 108, and a third laser source 110. Alternatively, the housing 102 may include a greater or fewer number of laser beam sources in order to meet the needs of a manufacturer or consumer. Each of the three laser sources 106 through 110 is in communication with the computing system 104. In the current embodiment the communicative link is a wireless system, however, alternate systems, such as serial cable, infrared, or the like may be employed.

In the present embodiment, the laser sources 106 through 110 are enabled to emit infrared laser beams. These laser beams are invisible to the human eye, however, light emitting diodes may be linked to the laser beam in order to provide a visual indicator of the travel of the laser beam. In an alternate embodiment the laser sources may be enabled to emit various types of laser beams, such as an ultraviolet laser beam, or the like without departing from the scope and spirit of the present invention.

Additionally, a first mounting member 112 and a second mounting member 114 are coupled with the housing 102. The number, location, and configuration of the mounting members may vary as contemplated by one of ordinary skill in the art. The mounting members are suitable for connecting the housing 102 to another device such as a power tool. The power tool may be a table saw, a belt sander, a planer, a disc sander, a lathe, a drill press, and the like. In the current embodiment the laser apparatus 100 is shown being suitable for mounting on a fence 116 which would normally be coupled with a table saw. As shown, the mounting members 112 and 114 include a first latch 124 and a second latch 126 which slide through and latch the housing 102 to a mounting assembly, power tool, or other devices. In the current embodiment the first and second latches 124 and 126 are compression latches. However, it is understood that the current latch system may be a variety of latching mechanisms without departing from the scope and spirit of the present invention.

The latches 124 and 126 are operably coupled with a first release mechanism 120 and a second release mechanism 122, respectively. In the present embodiment, the first and second release mechanisms 120 and 122 are depression buttons, operable by a user by pressing down on the buttons. However, other release mechanisms, such as switches, rotation knobs, or the like, may be employed without departing from the scope and spirit of the present invention. By depressing the buttons 120 and 122 the latches 124 and 126 are retracted into the mounting member upon which they are disposed. This allows the user to engage and remove the housing 102, of the laser apparatus 100, from the mounting assembly, power tool, or other device the user is currently operating. The location and number of release mechanisms may vary as determined by the number of mounting members and latches disposed on the laser apparatus 100.

The housing further provides the user a first grip 128 and a second grip 130 proximally located next to the buttons 120 and 122. The two grips 128 and 130 are ergonomically shaped to provide the user a secure location with which to grip the housing 102 for depressing the first and second buttons 120 and 122 and releasing the compression latches 124 and 126. The two grips may also be used in transporting the laser apparatus 100.

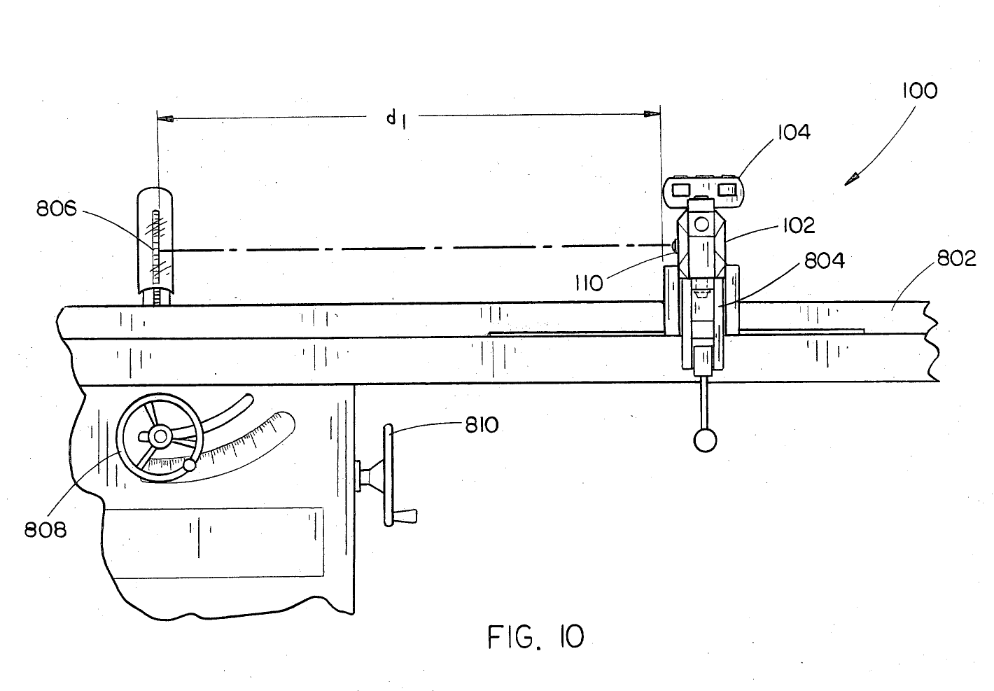

It is further contemplated that the laser apparatus 100 may include a laser source which emits an incident laser beam from either a first end 116 or a second end 118 of the housing 102. Such a configuration may be desirable in situations where a user needs only one laser beam to produce a finished work product, such as when working on a lathe machine as shown in FIG. 10.

In an alternate embodiment, the three laser beam sources 106, 108, and 110, may comprise modular laser source units. The modular laser source units may be capable of being removed from and inserted into the housing 102. The modular laser source units may be locked in position, once inserted into the housing 102, by use of a variety of system, such as a latch system, compression system, or the like. There may be a variety of modular laser source units disposed with laser sources of varying power. Further, the modular laser source units may include a dithering assembly enabling the laser source to provide dithering functionality. For further discussion on dithering assemblies see FIGS. 21 through 24 below.

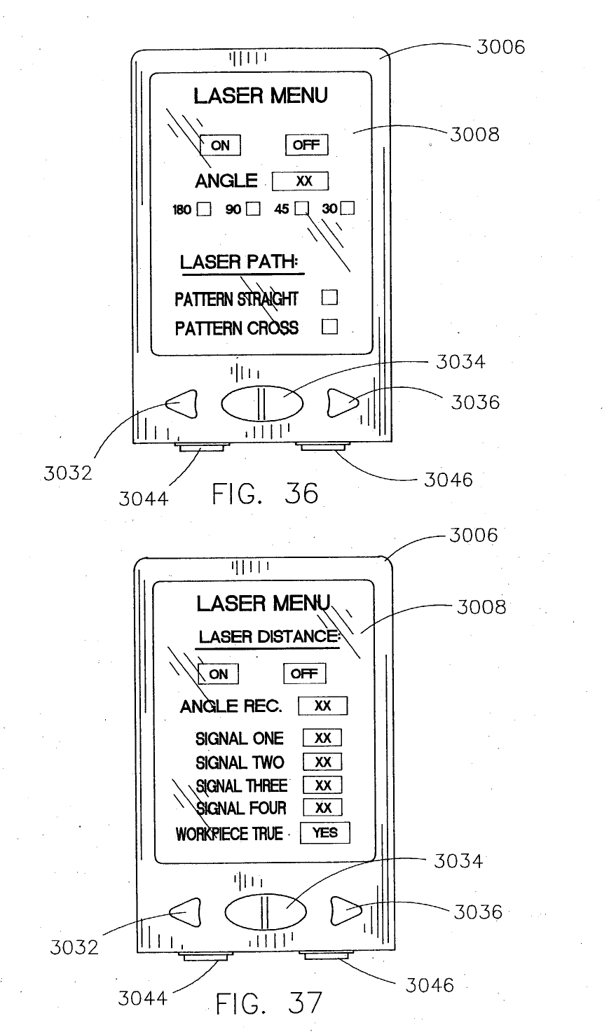

Further, the laser apparatus 100 may be comprised of a single laser source. The single laser source may emit an incident laser beam through the housing 102. The single laser source may be attached at either the first end 116 or the second end 118 of the housing 102. Alternatively, the single laser source may be included in the computing system 104. In a single laser source configuration optical splitters, optical reflectors, and photomultipliers may be employed in order to facilitate the functional capabilities of the laser apparatus 100. A detailed discussion of the single laser source design, including the use of optical splitters, optical reflectors, and photomultipliers, is provided in FIGS. 36 through 40.

In the present embodiment, the computing system 104 controls the functioning of each of the three laser sources 106 through 110. A user interacts with the computing system 104 and directs the emitting of a laser beam from each of the three laser sources. Additionally, the computing system 104 monitors the laser beams and provides a display to the user of relevant information.

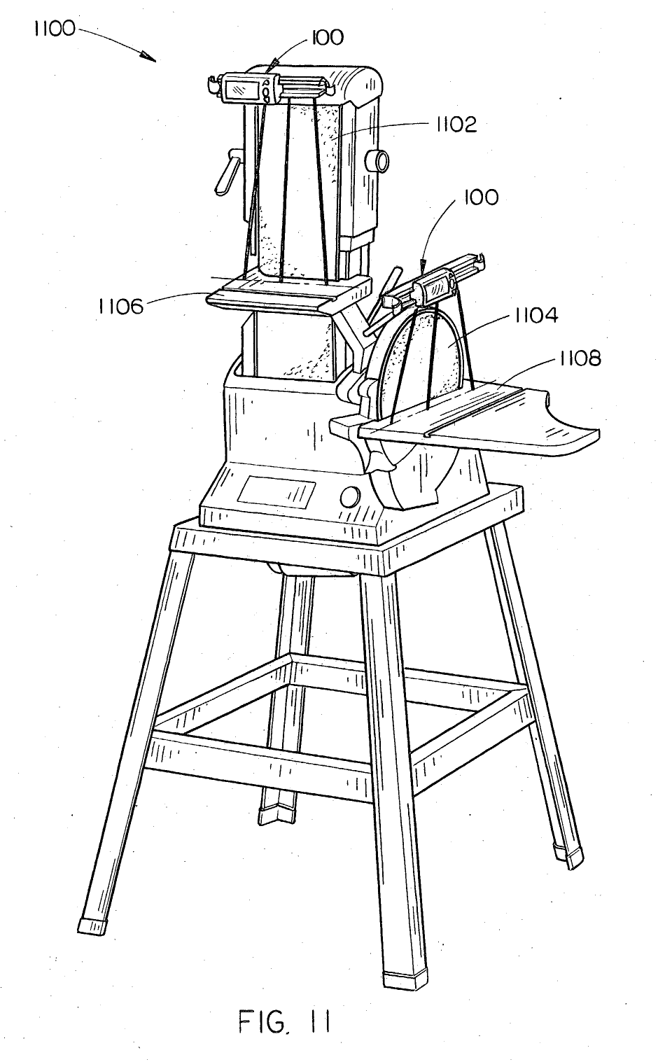

The information provided on the display may include distance measurements, blade height measurements, blade angle, and the like. Additionally, the laser beams may provide information regarding the truing of the machine and a work piece, and the indexing of the work piece. For example, in a belt sander apparatus as will be shown and discussed in FIG. 11, the user may ensure that the angle of the sander matches the desired specifications using the laser apparatus. Further, a work piece to be presented to the sander may be verified by the laser apparatus to be in the correct position for presentation to the sander. The laser apparatus may also provide an indexing functionality by determining the leading edge of the work piece and monitoring the distance traveled by the work piece. It is contemplated that other information relevant to a variety of power tools may also be provided by the computing system to the user.

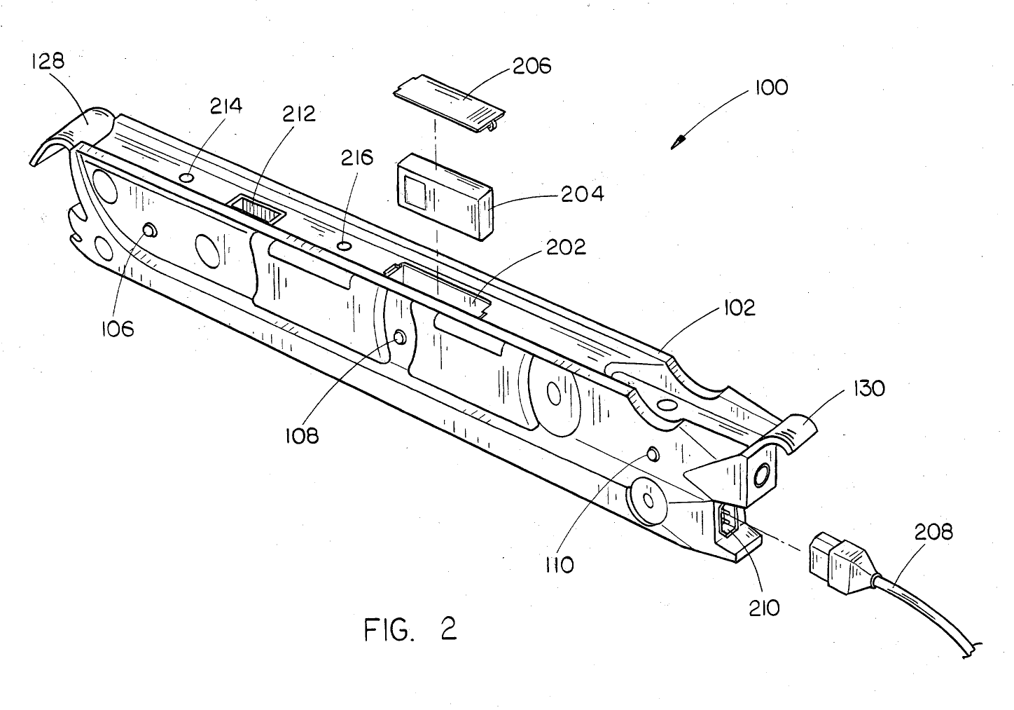

Referring now to FIG. 2, the laser apparatus 100 is shown. The housing 102 includes a first receptor port 202 suitable for receiving a portable power source 204. The portable power source 204 provides power for the operation of the laser sources disposed within the housing 102. The first receptor port 202 further includes a removable hatch 206 which fastens in place over the opening of the first receptor port 202. The portable power source 204 may be a variety of devices, such as a rechargeable battery or the like, without departing from the scope and spirit of the present invention.

Also shown in FIG. 2 is an alternate configuration of the housing 102 where power may be received via a power cord 208 which engages a second receptor port 210. It is understood that typically only one of the above mentioned power source configurations will be employed on the laser apparatus 100 and that FIG. 2 is only an exemplary embodiment of two possible configurations. Further, the location and configuration of the first and second receptor ports 202 and 210 may be varied as contemplated by one of ordinary skill in the art.

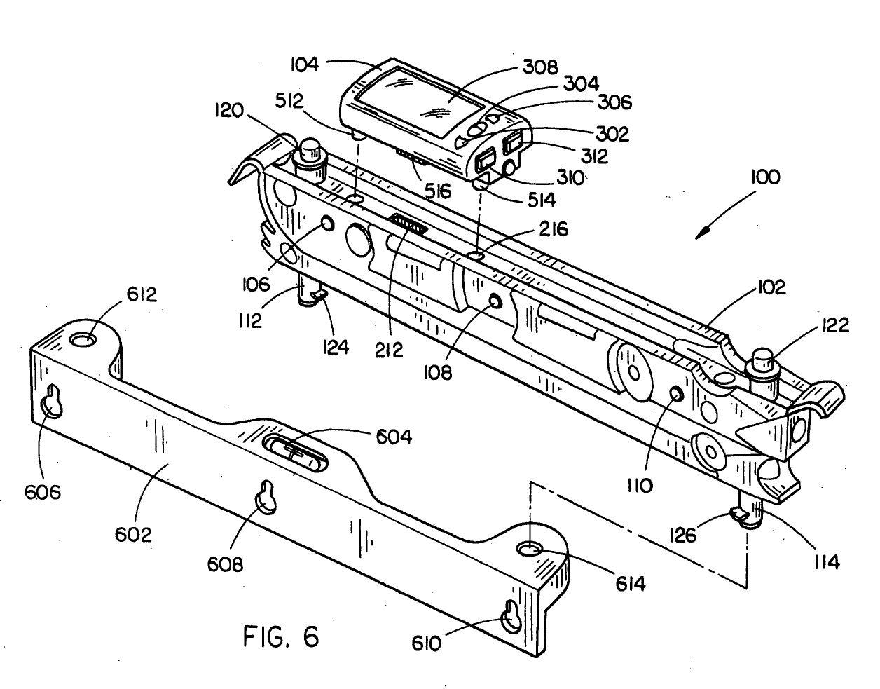

Additionally, a communication port 212 is included in the housing 102 of the laser apparatus 100. The communication port 212 provides a communicative link to the computing system 104, allowing the computing system to communicate with the laser sources 106 through 110 disposed within the housing 102. The location and configuration of the communication port 212 may vary as contemplated by one of ordinary skill in the art without departing from the scope and spirit of the present invention. Further, a first coupling port 214 and a second coupling port 216 are included on the housing 102 for coupling with the computing system 104 as will be further described in FIG. 6.

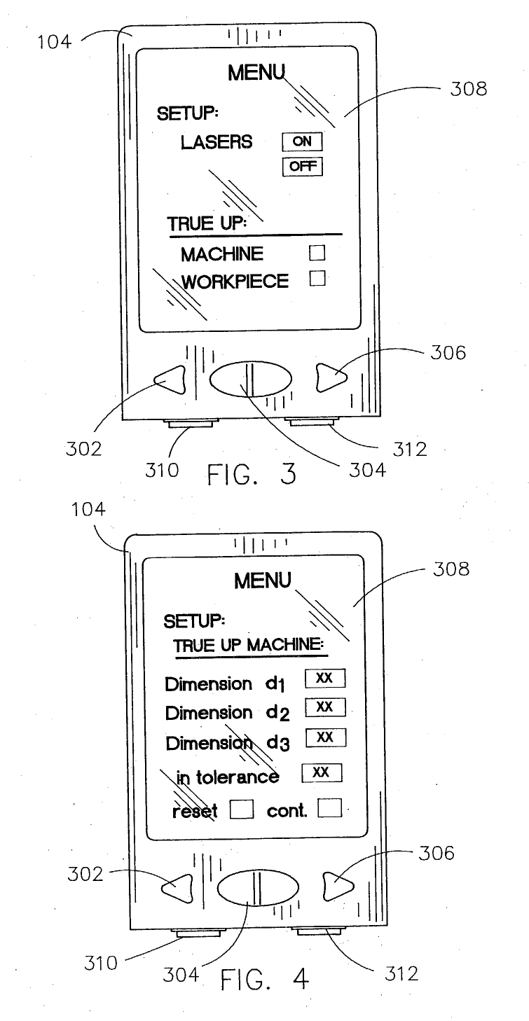

FIGS. 3 and 4 show exemplary displays on the computing system 104. Being an interactive system, the computing system 104 includes a first selector 302, a second selector 304, and a third selector 306. The first selector 302 and the third selector 306 allow a user to scroll through choices presented on a display screen 308 of the computing system 104. The second button 304 allows a user to select the desired application choice presented on the display screen 308. For example, in FIG. 3 a user may choose to turn on or turn off the lasers by using the first and third buttons 302 and 306 to select the desired function and then pressing the second button 304 to execute the function. In FIG. 4 the display screen 308 is providing a user with the readouts determined during the process of truing the machine. The user may accept these dimensions by selecting the “cont.” function or reject these dimensions by selecting the “reset” function. It is understood that the displays presented on the display screen 308 are exemplary and may not be read as exclusive. A variety of displays and interactive functionalities may be presented on display screen 308 without departing from the scope and spirit of the present invention.

Various configurations of the computing system 104 may be employed without departing from the scope and spirit of the present invention. Ergonomic shaping and providing additional capabilities is contemplated. The display screen may be a liquid crystal display, back lit monitor, or the like, while the selector features may include rollers, ball knobs, or the like.

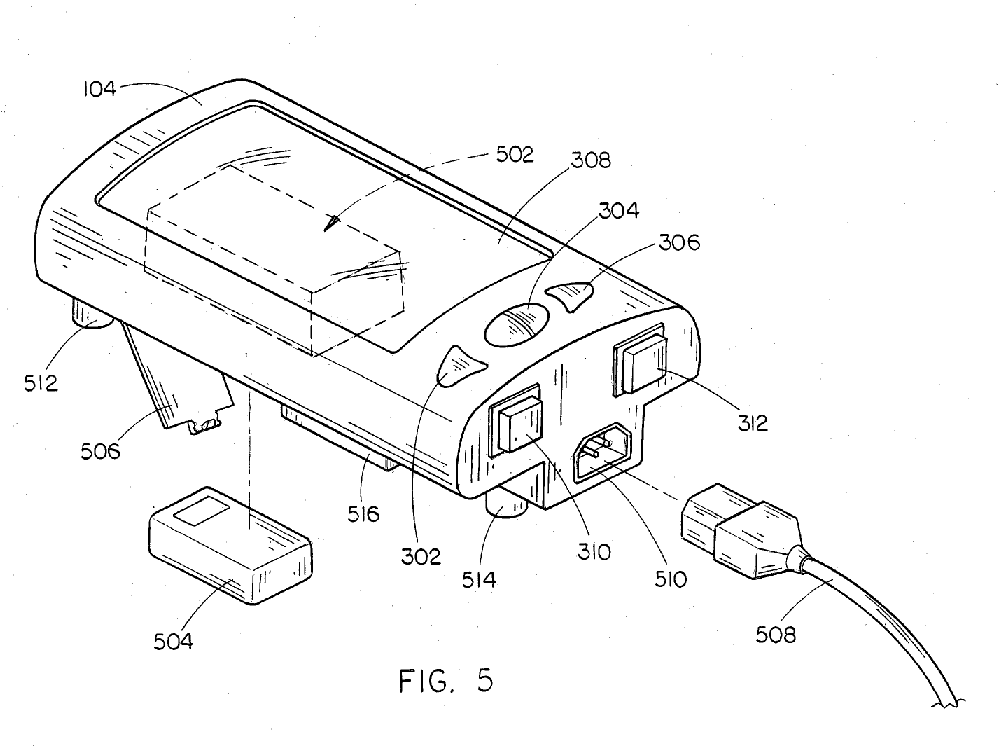

In the current embodiment, on one end of the computing system 104 are coupled a first button 310 and a second button 312. Preferably, these buttons are depression buttons, however, other systems as contemplated by one of ordinary skill in the art may be employed. The two buttons are used in the coupling and uncoupling of the computing system 104 with the housing 102 of the laser apparatus 100, as will be described in FIGS. 5 and 6.

In FIG. 5 the computing system 104 includes a first receptor port 502 suitable for receiving a portable power source 504. The portable power source 504 provides power for the operation of the computing system 104 that may be coupled to the housing 102 and is in communication with the laser sources. The first receptor port 502 further includes a removable hatch 506 which fastens in place over the opening of the first receptor port 502. As described for the portable power source 204 of the housing 102, the portable power source 504 may be a variety of devices, such as a rechargeable battery or the like, without departing from the scope and spirit of the present invention. In an alternate configuration the computing system 104 may receive power from a power cord 508 which engages a second receptor port 510. The location and configuration of the first and second receptor ports 502 and 510 may be varied as contemplated by one of ordinary skill in the art.

Additionally, the computing system 104 includes a first mounting member 512 and a second mounting member 514. These two mounting members couple with the housing 102 of the laser apparatus 104. It is contemplated that a latch and release mechanism is disposed within one of the two mounting members and operably connects with the two buttons 310 and 312. Further, the computing system 104 includes a communication adapter 516 that engages with the communication port 212, shown in FIG. 2, disposed on the housing 102.

Referring to FIG. 6, the laser apparatus 100 is shown with computing system 104 in vertical orientation over the communication port 212 and the first and second coupling ports 214 and 216. The first and second mounting members 512 and 514, disposed on the computing system 104, are positioned to engage with the first and second coupling ports 214 and 216, respectively. The communication adapter 516 is positioned to engage with the communication port 212. In this preferred embodiment, a user must supply sufficient force to couple the computing system 104 with the housing 102. As discussed above in FIG. 3, the first and second buttons 310 and 312 are operably engaged as part of a latch and release mechanism which locks the computing system 104 in place. A latch or latches may be located on the mounting members 512 and/or 514, and as the computing system 104 is pressed into place they may engage with the inside of the coupling ports 214 and/or 216. In order to remove the computing system 104 form the housing 102, the user will depress one or both of the first and second buttons 310 and 312, which will release the latches from the coupling ports allowing the computing system 104 to release from the housing 102. Other systems may be employed to affix the computing system 104 to the housing 102 without departing from the scope and spirit of the present invention.

The laser apparatus 100 is shown engaging a mounting assembly 602. Preferably, the mounting assembly 602 includes a leveling device 604. The mounting assembly includes a first mounting port 606, a second mounting port 608, and a third mounting port 610. Initially the mounting assembly 602 is mounted to a power tool or other desired device by using the mounting ports. It is contemplated that the mounting ports may be a variety of configurations as contemplated by one of ordinary skill in the art. Before the laser apparatus 100 is connected a user may establish that the mounting assembly 602 is in a level position by checking the leveling device 604. In this way the user may ensure that the laser apparatus 100 is level once it is connected to the mounting assembly 602. The mounting assembly 602 further includes a first coupling port 612 and a second coupling port 614 which engage the mounting members 112 and 114 of the laser apparatus 100.

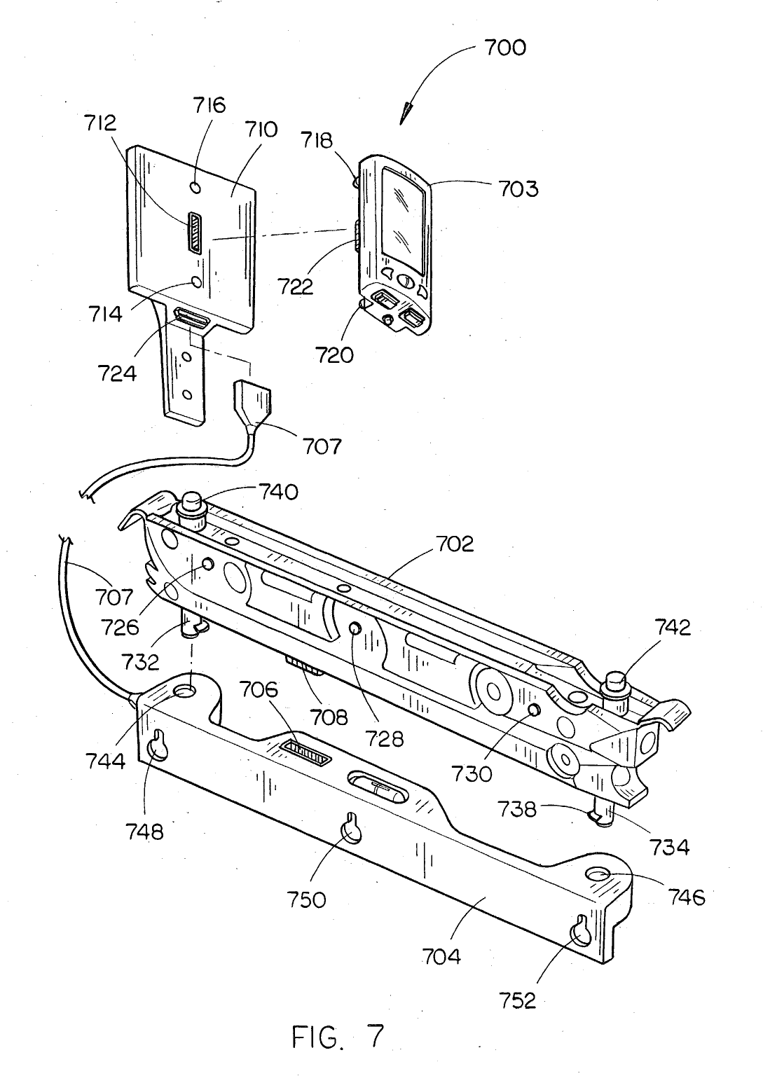

Referring now to FIG. 7, a laser apparatus 700 is shown. The laser apparatus 700 includes a housing member 702 in communication with a remote computing system 703. The housing member 702 is disposed with a first laser source 726, a second laser source 728, and a third laser source 730. Additionally, a mounting assembly 704 capable of connecting with the housing member 702 and providing a communication link between the housing member 702 and the remote computing system 703, is included.

The housing member 702 is similar to that shown and described in FIGS. 1, 2, and 6, except that the housing member 702 further includes a communication adapter 708 and does not include the communication port shown in FIGS. 2 and 6. The communicative adapter 708 communicatively couples with the remote computing system 703 by engaging the communication adapter 708 in the communicative coupling point 706. This communicative linking allows a user of the laser apparatus 700 to control the laser sources 726 through 730 through the use of the remote computing system 703. Additionally, the housing member includes a first mounting member 732 and a second mounting member 734. The first mounting member 732 is disposed with a compression latch 736 and is operably engaged with a first depression button 740. The second mounting member 734 is disposed with a compression latch 738 and is operably engaged with a second depression button 742. The first mounting member 732 couples with a first coupling port 744 disposed on the mounting assembly 704, and the second mounting member 734 couples with a second coupling port 746 disposed on the mounting assembly 704. As described previously the first and second depression buttons allow the user to remove the housing member 702 from the mounting assembly 704.

The remote computing system 703 is similar to that shown and described in FIGS. 1, and 3 through 6 except that it couples with a remote mounting member 710. The remote mounting member 710, preferably, mounts to a stationary surface, such as a wall, and provides a first communication port 712 for coupling with a communication adapter 722 disposed on the remote computing system 703. Additionally, the remote mounting member 710 includes a first coupling port 714 and a second coupling port 716 for coupling with a first mounting member 718 and second mounting members 720 of the remote computing system 703. Further, the remote mounting member 710 includes a second communication port 724 which couples with a communication adapter 707 connected to the mounting assembly 704.

The mounting assembly 704 is similar to the mounting assembly shown in FIG. 6, except that the mounting assembly 704 further includes a communicative coupling port 706 and a communication adapter 707. The communication adapter 708, disposed on the housing member 702, engages with the communication port 706 providing a communicative link. The communicative link from the housing member 702 to the remote computing system 703 is completed through the coupling of the communication adapter 707 with the second communication port 724 of the remote mounting member 710. The mounting assembly 704 includes a first mounting port 748, a second mounting port 750, and a third mounting port 752. These mounting ports allow the mounting assembly 704 to be coupled to a variety of devices such as power tools and the like.

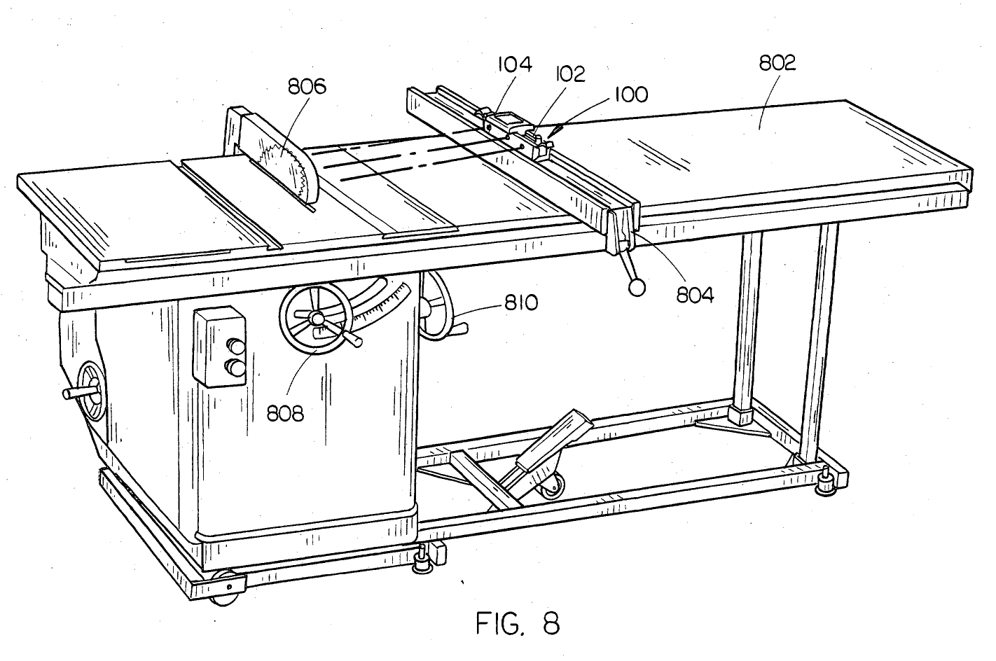

A table saw system 800 including the laser apparatus 100 mounted on a fence 804 which is connected to a table saw 802, is shown in FIGS. 8, 9, and 10. Preferably, the laser apparatus 100 provides three laser beams. The laser beams may be used to establish three distance measurements indicated by d1, d2, and d3. These measurements are displayed to the user on the computing system 104. Additionally, the laser beams in communication with the computing system 104 may display a variety of information, such as circular saw blade height, circular saw blade angle, or the like. The table saw 802 further includes a circular saw blade 806, a first adjustment mechanism 808, and a second adjustment mechanism 810. In the present embodiment, the first adjustment mechanism 808 enables a user of the table saw 802 to adjust the angle of the circular saw blade 806 relative to the operational field of the table saw 802. The operational field may be defined as that area of the table saw 802 upon which a work piece may be placed and the circular saw blade 806 may perform a cut upon the work piece. In other embodiments where the laser apparatus 100 is mounted or connected to another power tool or device the operational field may include the area where the work piece is placed and a function is performed upon the work piece. The second adjustment mechanism 810 enables a user to adjust the height which the circular saw blade 806 extends above the surface of the operation field of the table saw 802.

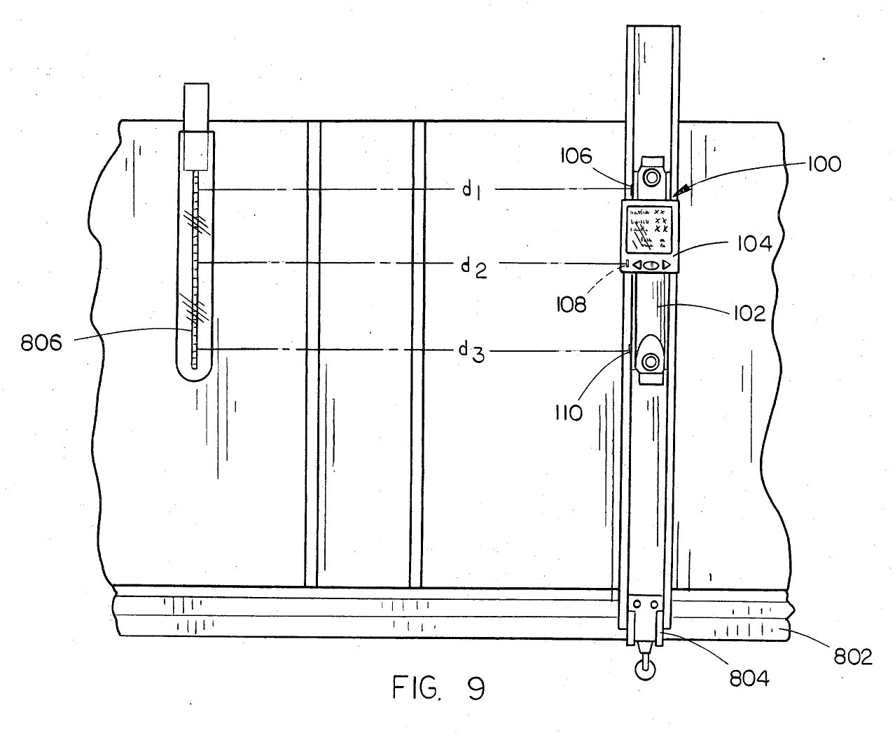

Referring now to FIGS. 9 and 10, the laser apparatus 100 coupled to a table saw 802 is shown. The laser apparatus 100 includes the housing 102 coupled with the computing system 104. The housing 102 is mounted to a fence 804 connected to the table saw 802. In FIG. 10 the single laser source 110 is shown, the laser source 110 is being used to measure the distance d1 from the fence 804 to a circular saw blade 806. In FIG. 9 the housing 102 includes the first laser source 106, the second laser source 108, and the third laser source 110 each emitting a laser beam across the operational field of the table saw 802, from the fence 804 to the circular saw blade 806.

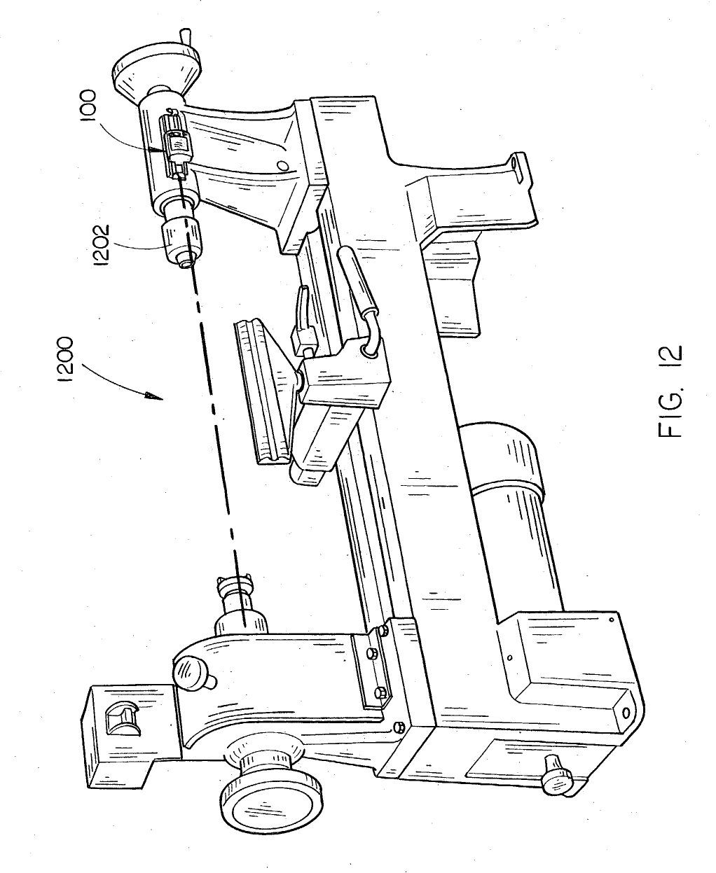

Referring now to FIGS. 11 and 12, the laser apparatus 100 is shown coupled to a sander system 1100 and a lathe system 1200. In FIG. 11 the sander system 1100 includes a belt sander 1102 with an operational field 1106 and a disc sander 1104 with an operational field 1108. In the current embodiment, two of the laser apparatus 100 systems are employed. One is mounted upon the belt sander 1102 and the other is mounted upon the disc sander 1104. The laser apparatus 100 may provide information on the angle of the sander relative to the operational field and the height the sander extends above the operational field. In FIG. 12 the laser apparatus 100 is coupled to the lathe 1202 and employs a single laser source configuration. The laser source emits a single laser beam which travels down one side of the operational field of the lathe 1202. The laser source may monitor the size of the work piece coupled with the lathe and indicate to the user when the desired work piece size has been reached. In both FIGS. 11 and 12 the location and configuration of the laser apparatus 100 may vary as contemplated by one of ordinary skill in the art.

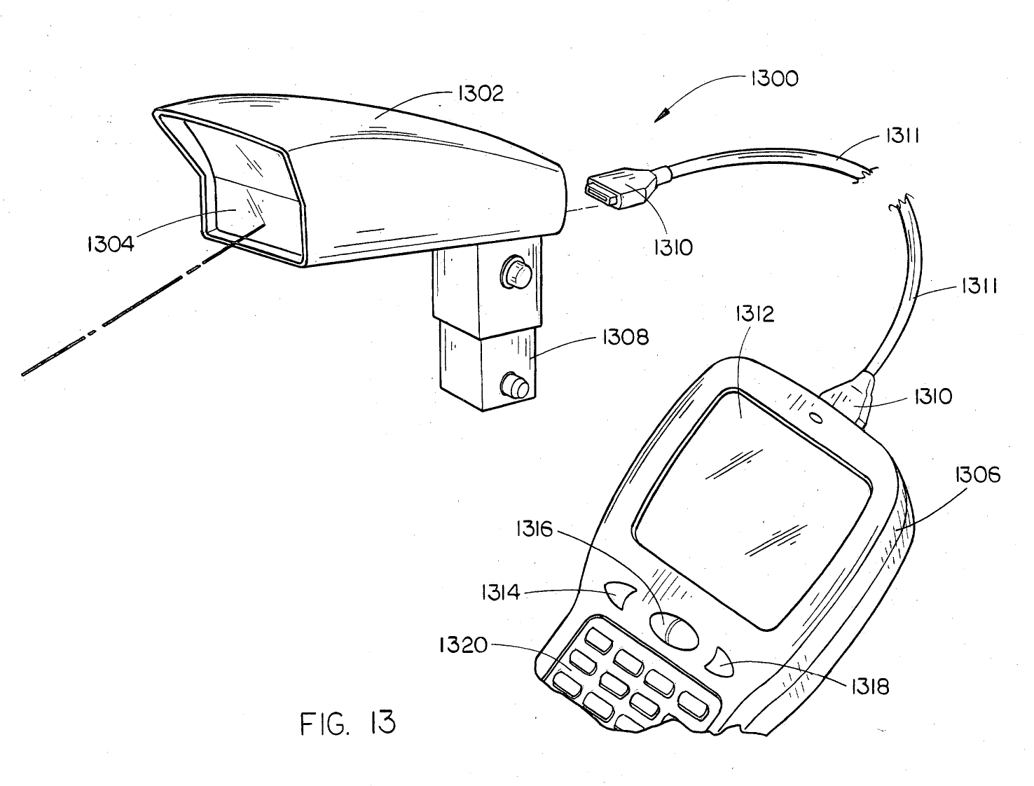

Referring now to FIG. 13 a laser light indicia and reading assembly 1300 is shown. In the current embodiment, the laser light indicia and reading assembly 1300 comprises a housing 1302 which includes a laser source 1304 in communication with a computing system 1306. The housing 1302 is coupled with a mounting member 1308. A communication adapter 1310 communicatively couples the computing system 1306 with the laser source 1304 disposed within the housing 1302 through a cable 1311. The type of cable employed in the present embodiment is a standard serial cable. However, it is contemplated that a variety of connection mechanisms may be employed, such as wireless, infrared, or the like. The computing system 1306 is similar to the computing system 104 in that it provides a display screen 1312, a first selector 1314, a second selector 1316, and a third selector 1318. Additionally, the computing system 1306 may further include a keypad 1320, as shown in the current embodiment. The keypad 1320 may enable increased functionality of the computing system, such as increased control over the laser source.

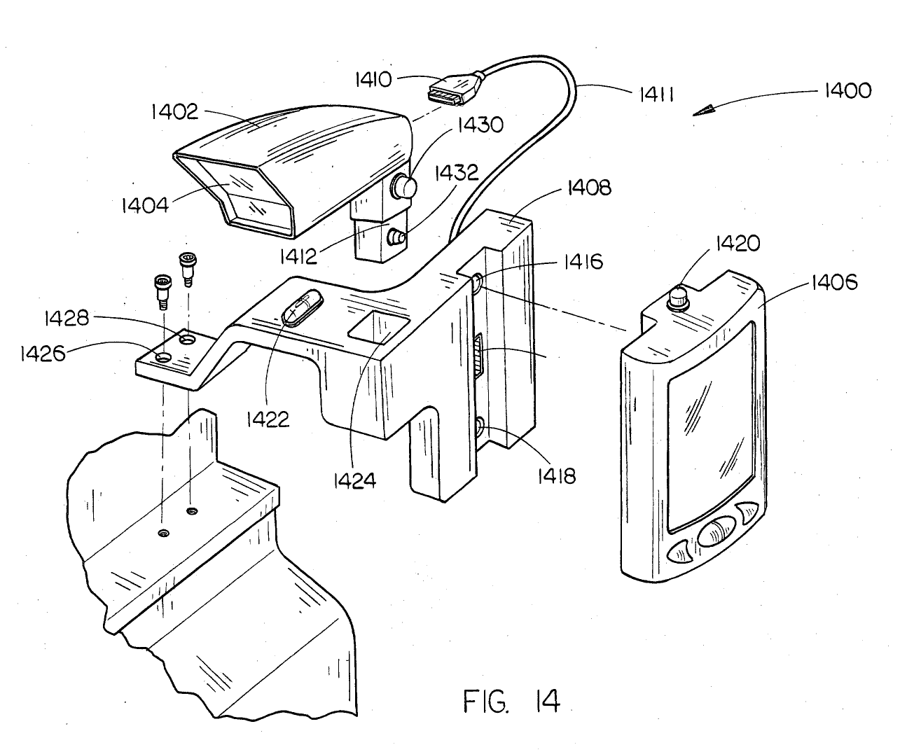

In FIG. 14 a laser light indicia and reading assembly 1400 is shown. In the present embodiment, the laser light indicia and reading assembly 1400 comprises a housing 1402 which includes a laser source 1404, a computing system 1406, and a mounting assembly 1408. The housing 1402 is coupled with a mounting member 1412 for coupling with the mounting assembly 1408. The mounting assembly 1408 further includes a communication adapter 1410 which couples with the laser source 1404 through the housing 1402. Preferably, the communication adapter 1410 is coupled with a cable 1411 which connects to the mounting assembly 1408. It is understood that the configuration of the communication adapter 1410 and type of cable 1411 employed may vary as contemplated by one of ordinary skill in the art. Through the serial cable 1411 the communication adapter 1410 is further communicatively coupled with the communication port 1414.

In the present embodiment, the communication port 1414 is designed to couple with the computing system 1406 when it is mounted to the mounting assembly 1408. Further, a first coupling port 1416 and a second coupling port 1418 are disposed on the mounting assembly 1408 and further engage with the computing system 1406 when the computing system 1406 is mounted to the mounting assembly 1408. The computing system 1406 is similar to the computing system 104 shown and described previously, except that the computing system 1406 includes an indicator 1420. The indicator 1420 is a light emitting diode (LED) which provides indication to the user of the system 1400 when the computing system 1406 is properly mounted and engaged with the mounting assembly 1408. It is contemplated that the computing system 1406 may not include indicator 1406. However, a variety of configurations may be employed for indicator 1420 without departing from the scope and spirit of the present invention.

A leveling device 1422 is disposed within mounting assembly 1408. As shown and described previously in FIGS. 6 and 7 the leveling assembly ensures that the laser light indicia and reading assembly 1400 is level with the device to which it is connected. A first mounting port 1426 and a second mounting port 1428 are employed to connect the mounting assembly 1408 with the desired device. In the present embodiment the mounting ports allow for screws to be inserted and fastened to the device and the mounting assembly 1408. However, it is contemplated that a variety of fastening devices and configurations may be employed.

The mounting assembly 1408 further comprises a laser source coupling port 1424. The laser source coupling port 1424 is designed to receive the mounting member 1412 which is coupled to the housing 1402 disposed with the laser source 1404. The mounting member 1412 includes a release mechanism comprised of a button 1430 disposed on the housing 1402, and a latch 1432. The button 1430 is a depression button, operably engaged with the latch 1432, which the user may depress in order to activate the latch 1432. The latch 1432 is a compression latch which retracts back into the mounting member 1412 when the button 1430 is depressed. The latch 1432 is extended away from the mounting member 1412 and engages the inner surface of the laser source coupling point 1424 to affix the housing 1402 to the mounting assembly 1408.

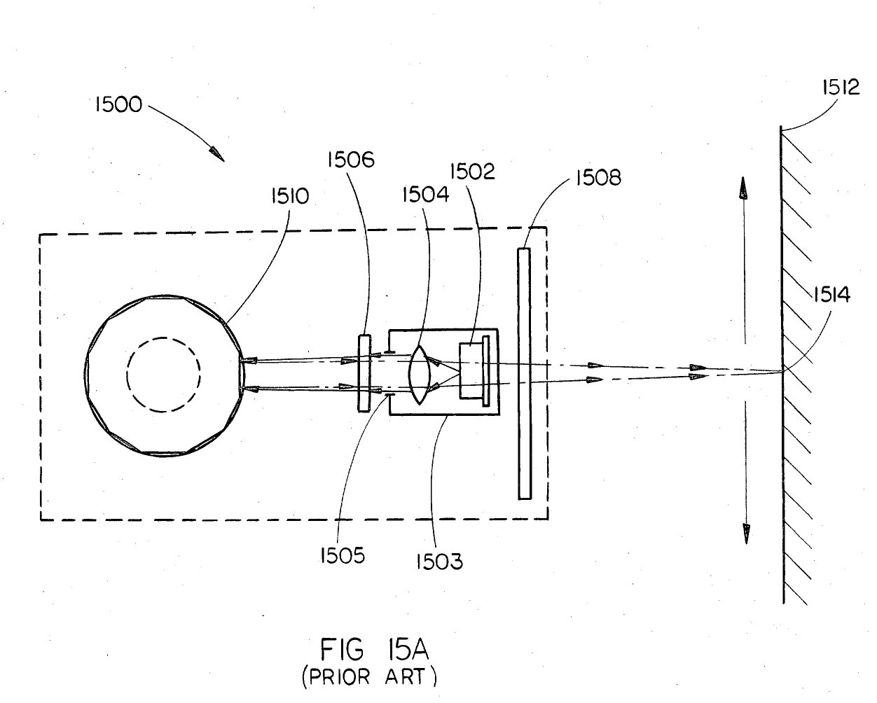

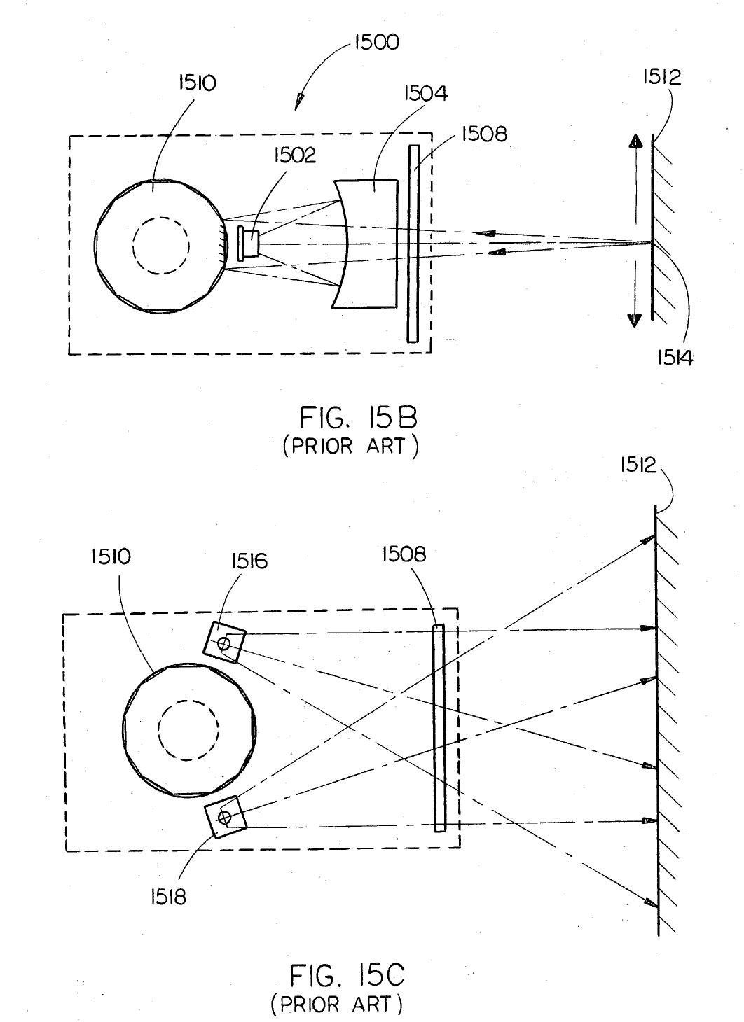

In the preferred embodiment, the laser source for both FIGS. 13 and 14 is enabled as a standard single laser beam producing laser source. Alternatively, the laser source in both FIGS. 13 and 14 may be enabled as a scanning module. A known scanning module 1500 is shown in FIGS. 15A, 15B, and 15C. The scanning module 1500 comprises a laser source 1502 with a spherical lens 1504 disposed in a housing 1503. The housing 1503 includes an aperture 1505 through which a laser beam, emitted from the laser source 1502 through the spherical lens 1504, passes. The laser beam travels through a cylindrical lens 1506 and strikes a multifaceted polygon deflector 1510. The multifaceted polygon deflector 1510 deflects the incident laser beam emitted by the laser source through the cylindrical lens 1508 and out to a surface 1512. The surface 1512 is a nominal plane and the incident laser beam is provided a first focus 1514. As indicated by the arrows the scanning module 1500 moves the focused laser beam along the surface 1512. The scanning module may further include two light emitting diode assemblies 1516 and 1518. These assemblies emit a visible light that tracks the position of the laser beam providing an indicator for a user of the scanning module.

The laser beam from the scanning module 1500 may appear as a continuous line defined by the angle of incidence with which the laser beam strikes the multifaceted polygon deflector 1510. As such, the light emitting diodes would provide the visual indication of the defined area to the user.

The scanning module 1500 receives the reflected laser beams through the cylindrical lens 1508. The reflected laser beams may travel directly to the photodetector 1520 or the laser beams may travel to the multifaceted polygon deflector. The laser beams which strike the multifaceted polygon deflector are deflected to a collecting mirror 1522 where they are reflected to the photodetector 1520. In this manner the scanning module 1500 is enabled to read a surface it is scanning.

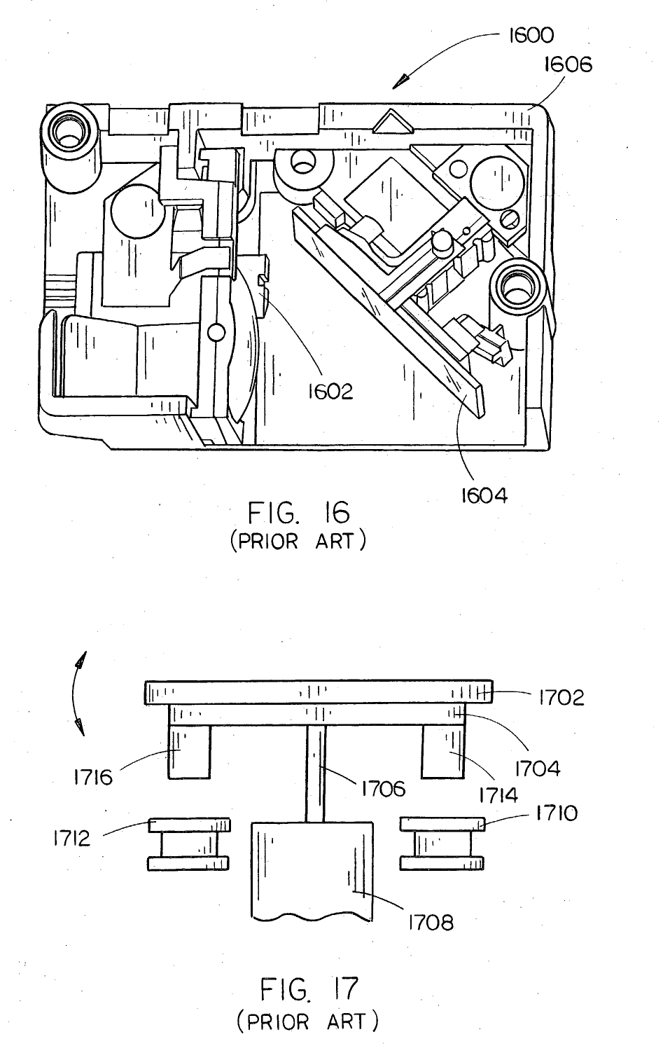

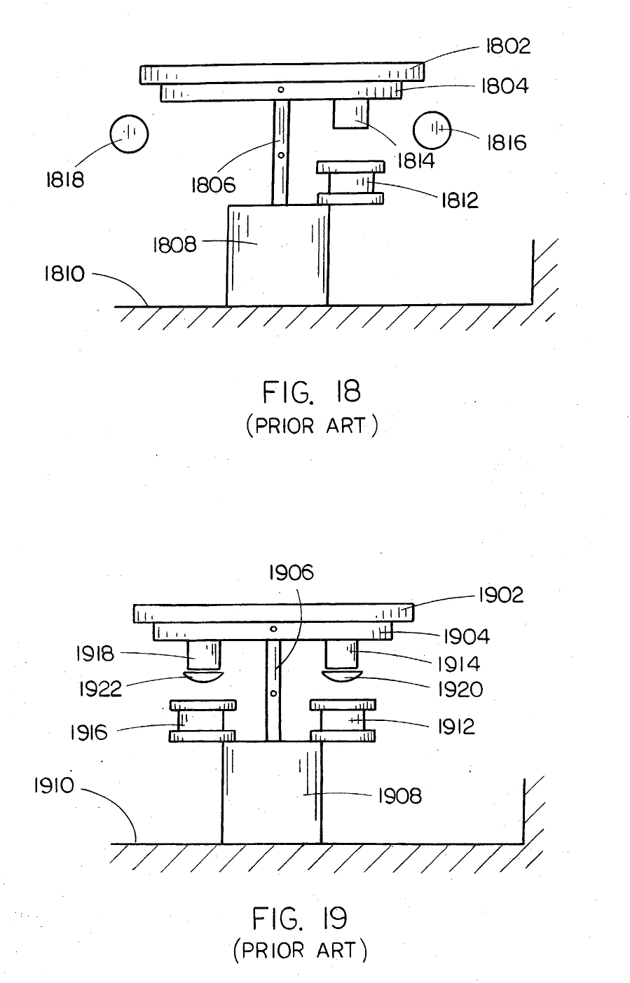

It is contemplated that the laser source(s) employed in the laser light indicia and reading assembly and the laser apparatus may include a dithering assembly. A typical dithering assembly 1600, known in the art, is shown in FIG. 16. The dithering assembly 1600 includes a laser source 1602 and a mirror 1604 disposed within a housing 1606 and may be employed to establish a laser beam which presents as a continuous line upon a surface. Further, it is known that dithering assemblies may comprise a pair of magnets and a pair of magnetic coils. As shown in FIG. 17 a mirror 1702 is coupled to a base 1704 which is connected to a flexible support arm 1706 that is connected to a support member 1708. A drive coil 1710 is positioned on one side of the flexible support arm 1706 and a feedback coil 1712 is positioned on the opposite side of the flexible support arm 1706. A drive magnet 1714 is connected to the base 1704 and proximally located to the drive coil 1710 while a feedback magnet 1716 is connected to the base 1704 and proximally located to the feedback coil 1712. A drive current (e.g., an oscillating drive current) is run through the drive coil 1710 and causes the mirror 1702 to rotate. The rotation imparted to the mirror 1702 causes a change in the angle of incidence of the laser beam striking the mirror, and thus imparts a change in the angle of reflection imparted to the incident laser beam. As a result, the reflected laser beam appears as a continuous line defined by the rotational range of the mirror 1702.

Additionally, dithering assemblies which control the range of rotation of the mirror are known. FIG. 18 shows one such assembly where a mirror 1802 is connected to a base 1804, which is connected to a flexible support arm 1806 that is connected to a support member 1808 coupled to a surface 1810. A drive coil 1812 is coupled to the support member 1808 in proximal relation to a drive magnet 1814 which is coupled with the base 1804. A first travel stop 1816 and a second travel stop 1818 are disposed in a desired location relative to the mirror 1802 to provide a limited range of rotation by the mirror 1802.

Alternative methods for controlling the range of rotation of the mirror in a dithering assembly may include the use of pads, as shown in FIG. 19. The mirror 1902 is connected to a base 1904, which is connected to a flexible support arm 1906 that is connected to a support member 1908 coupled to a surface 1910. A drive coil 1912 is coupled to the support member 1908 in proximal relation to a drive magnet 1914 which is connected to the base 1904. A feedback coil 1916 is coupled to the support member 1908 in proximal relation to a feedback magnet 1918, which is connected to the base 1904. A first pad 1920 is coupled with the drive magnet 1914, and a second pad 1922 is coupled with the feedback magnet 1918. The pads, which impact with the drive and feedback coils, limit the rotation range of motion of the mirror 1902.

In many dithering assemblies the effects of feedback between the drive coil/magnet and the feedback coil/magnet may have harmful effects, such as increased noise and unstable rotational amplitude production. A feedback sensor, such as a Hall sensor, may be employed to monitor electrical potential in a dithering assembly and trigger a switching of the polarity of the drive current in the drive coil at the appropriate time in relation to the position of the mirror. This switching of polarities reverses the drive force being exerted on the drive magnet and the mirror.

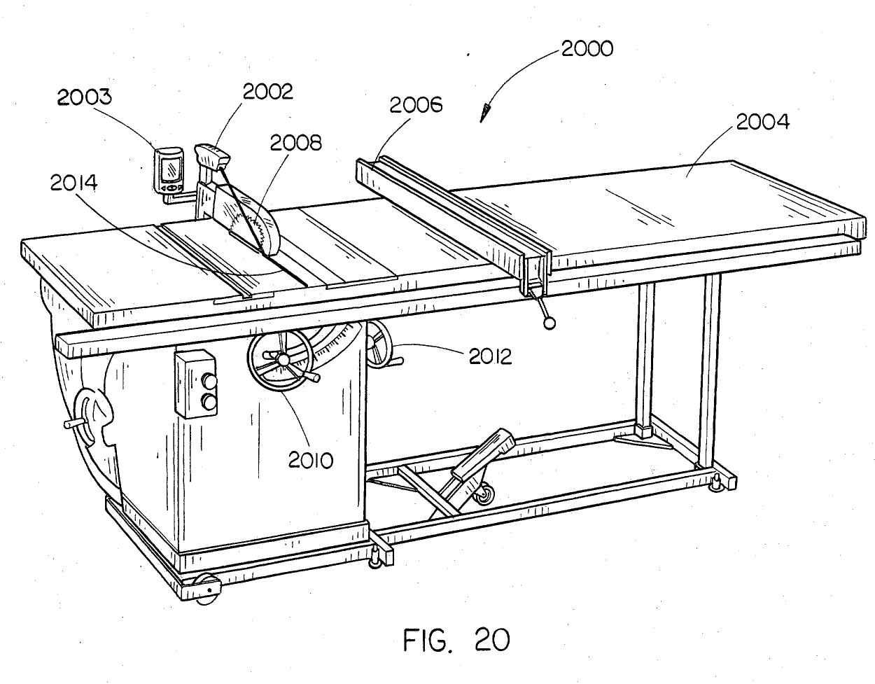

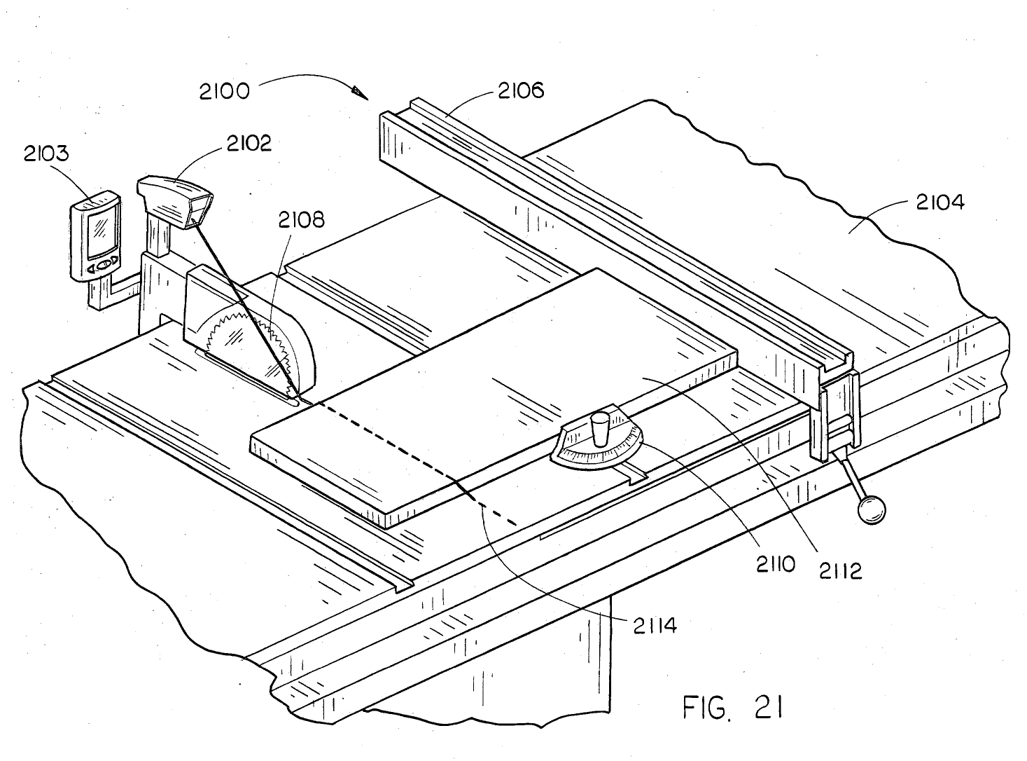

Referring now to FIG. 20, a table saw system 2000 including a laser light indicia and reading assembly 2002, is shown. The laser light indicia and reading assembly 2002 is similar to the laser light indicia and reading assembly 1300 and 1400 shown in FIGS. 13 and 14, and includes a computing system 2003 similar to that shown in FIGS. 13 and 14. In the current embodiment, the table saw system 200 further includes a table 2004, a fence 2006, and a circular saw blade 2008. Additionally, a first adjustment mechanism 2010 and a second adjustment mechanism 2012 are included in the table saw system 200 and operably engage with the circular saw blade 2008 to adjust blade angle and blade height relative to the operational field of the table saw system 2000, as described previously in FIG. 8.

In this embodiment the laser light indicia and reading assembly 2002 establishes a continuous laser beam line 2014. The laser beam line 2014 is laid down across the operational field of the table saw system 2000 and provides a cut line for a user of the system. It is contemplated that the laser light indicia and reading assembly 2002 will establish a laser beam line that tracks the position of the circular saw blade 2008. For example, if the user adjusts the angle of the circular saw blade 2008 relative to the operational field of the table saw system 2000, the laser light indicia and reading assembly 2002 will monitor that change and establish a laser beam line that tracks the position of the circular saw blade 2008.

In an alternate embodiment the laser beam line 2014 may be established using optically activated indicators that are integrated with the table 2004 in positions proximal to the circular saw blade 2008. For example, the table 2004 may be integrated with sensors which respond by illuminating upon being struck by light from the laser light indicia and reading assembly 2002. Alternately, optically activated cables may be integrated into the table saw to provide a laser line. Regardless of the type of optically activated indicators, their positioning relative to the circular saw blade 2008 and the lines of cut that may be established through use of the adjustment mechanisms provides a user an easily ascertained path to guide the cutting of the work piece by.

Referring now to FIG. 21, a table saw system 2100 is shown. The table saw system 2100 comprises a laser light indicia and reading assembly 2102, a table 2104, a fence 2106, and a circular saw blade 2108. The laser light indicia and reading assembly 2102 is coupled to a computing system 2103, similar to that previously described in FIGS. 13 and 14. Additionally, a work piece 2112 is located within the operation field of the table saw system 2100 and is being guided by the fence 2106 and an angular adjustment mechanism 2110. The angular adjustment mechanism 2110 may position the work piece 2112 in a desired angular setting and then guide the work piece 2112 through the circular saw blade 2108 at the set angle. In the current embodiment the laser light indicia and reading assembly establishes a laser beam light line 2114 across the work piece 2112. This laser beam light line 2114 may be used by the user as the cut line and followed throughout the cut.

It is contemplated that the laser light indicia and reading assemblies 2002 and 2102 of FIGS. 20 and 21 may include an indexing and truing functionality. An example of the truing of a work piece may include a user attempting to make a forty five degree angled cut on the work piece. The user may enter this information into the computing system in communication with the laser light indicia and reading assembly and when the work piece is set into the operational field of the table saw system, the laser light indicia and reading assembly may emit a laser beam which identifies the angle that the work piece is set at in relation to the circular saw blade. An example of the indexing of a work piece may include a user attempting to make a notch cut into a work piece that does not run the length or width of the work piece. When the work piece is set into the operational field of the table saw system, the laser light indicia and reading assembly may emit a laser beam which determines the position of the leading edge of the work piece. As the work piece is passed across the circular saw blade, the laser beam enables the laser light indicia and reading assembly to monitor the rate of travel imparted to the work piece and the overall distance of travel across the circular saw by the work piece. In this manner the laser light indicia and reading assembly may communicate to the computing system when the desired length of cut has been accomplished, and have that information passed on the user.

The user may be notified as to the truing and indexing information through the computing system, as previously discussed. Alternatively, the laser light indicia and reading assembly may be provided with an indicator to communicate to the user that the desired specifications have been accomplished. For example, a red light emitting diode may be coupled to the housing of the laser light indicia and reading assembly for indicating to the user that the desired function has not been accomplished. A green light emitting diode, coupled to the housing of the laser light indicia and reading assembly, may indicate to the user that the desired function has been accomplished and it is time to proceed or remove the work piece from the field of operation. Other indication systems as contemplated by one of ordinary skill in the art may be employed without departing from the scope and spirit of the present invention.

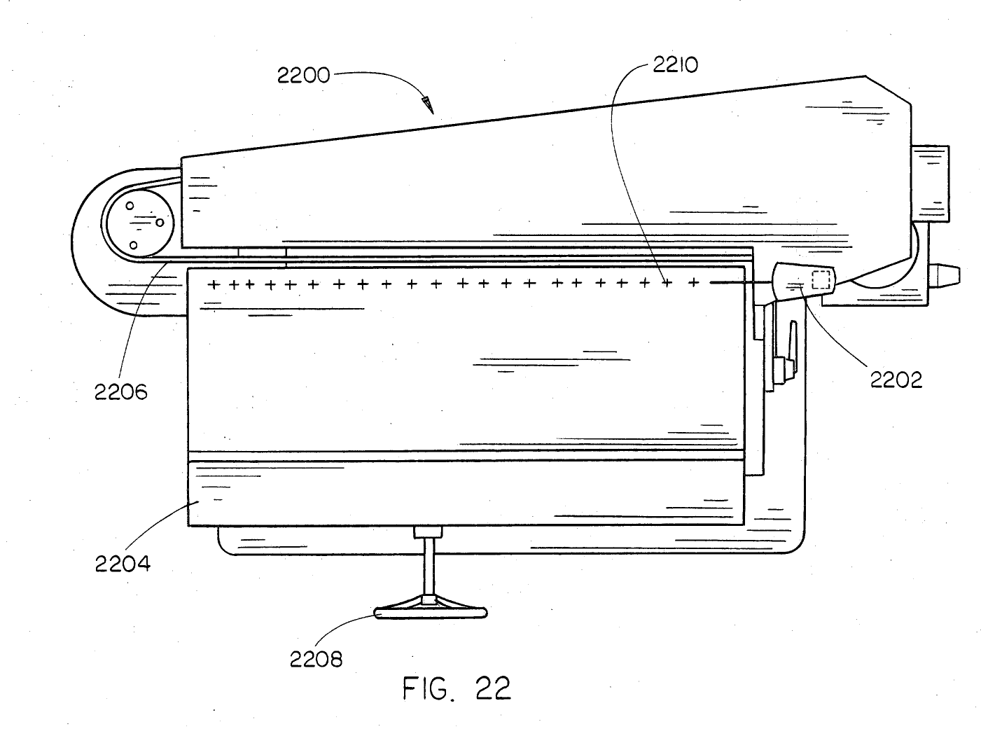

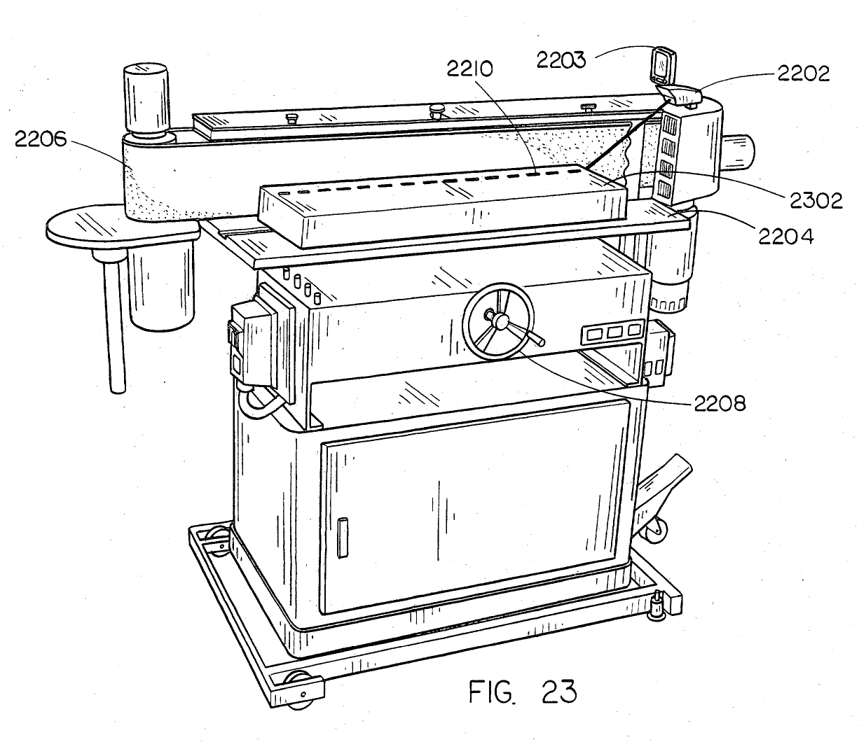

Referring now to FIGS. 22 and 23, an edge sander system 2200, is shown. In the current embodiment, the edge sander system 2200 includes a laser light indicia and reading assembly 2202, a work table 2204, belt sand paper 2206, and an adjustment mechanism 2208. A computing system 2203 is coupled to the laser light indicia and reading assembly 2202. The laser light indicia and reading assembly 2202 and the computing system 2203 are similar to those shown in FIGS. 13 and 14. The laser light indicia and reading assembly 2202 may be enabled for truing and indexing of the edge sander and a work piece (such as work piece 2302 shown in FIG. 23) as previously described in FIGS. 20 and 21. For example, a user of the edge sander system 2200 may be attempting to sand off a one-quarter inch segment from a work piece. In the process of sanding, one end of the work piece may be receiving greater pressure than the other resulting in an uneven depth of sanding. The laser light indicia and reading assembly 2200 may indicate to a user that uneven pressure is being applied and identify the end where this is occurring and the corrections that need to be made to true the work piece.

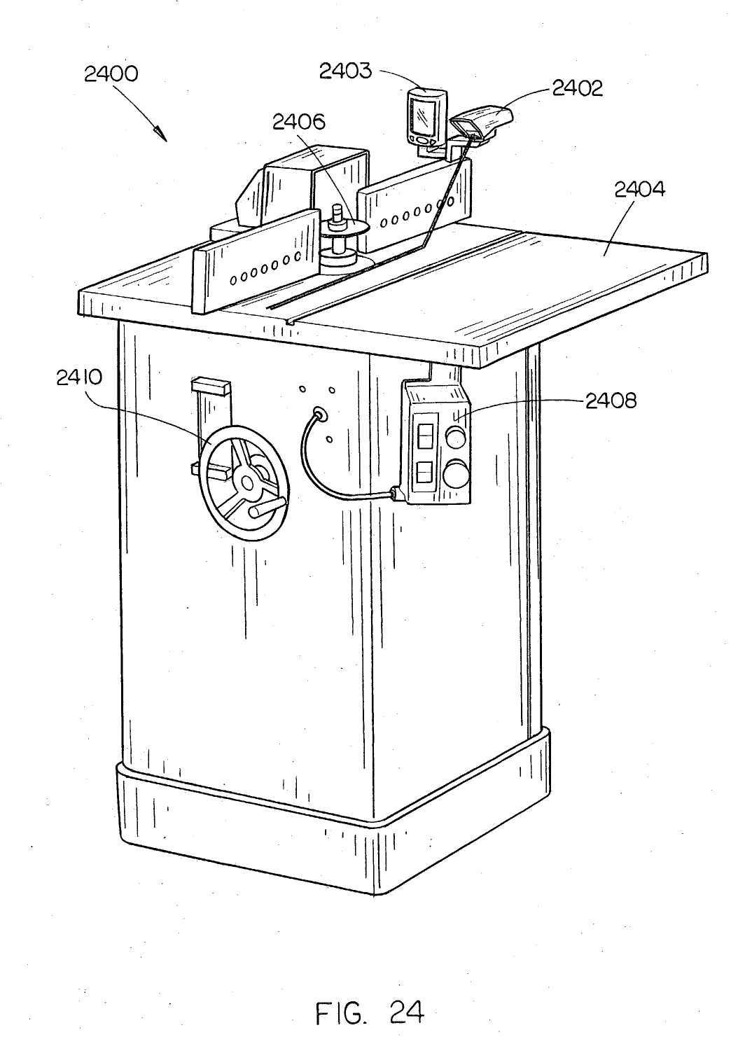

Referring now to FIG. 24, a wood shaper system 2400 is shown. In the present embodiment, the wood shaper system 2400 includes a laser light indicia and reading assembly 2402, a work table 2404, a bit 2406, an on/off mechanism 2408, and an adjustment mechanism 2410. A computing system 2403 is coupled to the laser light indicia and reading assembly 2402. The laser light indicia and reading assembly 2402 may be enabled to determine the angle of presentation and the size of the bit 2406. Additionally, the laser light indicia and reading assembly 2402 may be enabled for truing and indexing of the wood shaper system and a work piece being operated upon by the wood shaper system as described previously.

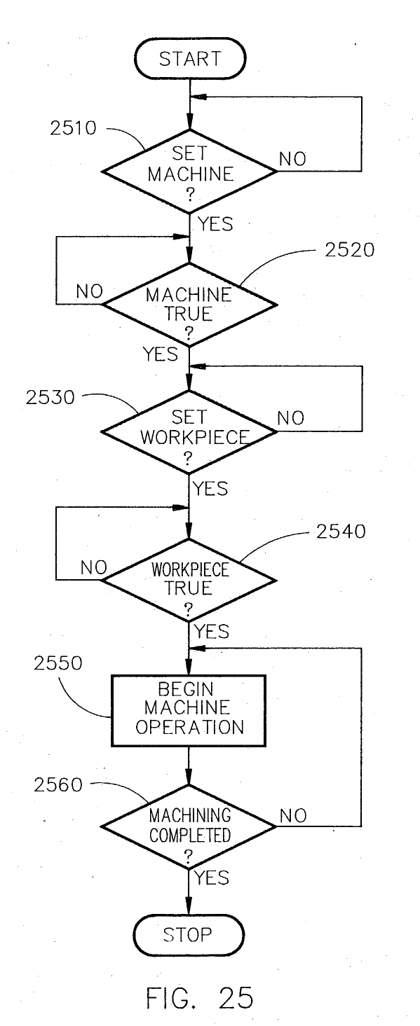

A flowchart illustrating functional steps which may be accomplished using the laser apparatus of FIGS. 1 through 12 and the laser light indicia and reading assembly of FIGS. 13 through 24, is shown in FIG. 25. The first step 2510 involves the setting of the machine. This involves mounting the laser apparatus to the power tool being utilized. As discussed previously, the laser apparatus may be directly mounted to a power tool or mounted to a separate mounting assembly which is connected to the power tool. Once the laser apparatus has been properly set then in step 2520 the laser apparatus must be trued in order to provide accurate results. This may be accomplished by checking the leveling mechanism as described previously, if such a mounting assembly is being employed or using the laser beams to determine the correct alignment. If the laser apparatus determines that the mounting is untrue it notifies the user. Once the laser apparatus determines it is truly aligned then in step 2530 the work piece is set. Once the laser apparatus determines that the work piece has been set then in step 2540 it determines if the setting of the work piece is true. Once the work piece is trued the user begins operation of the power tool in step 2550. When it is determined that the machining of the work piece is completed in step 2560 operation of the power tool is halted.

It is contemplated that an optically reflective material may be disposed upon a surface that is struck by the laser beam emitted from the laser apparatus or the laser light indicia and reading assembly. In this manner when the laser beams are emitted they will strike the optically reflective material and be reflected. In one embodiment the reflected laser beams may be received by an optical detector disposed within the housing of the laser apparatus or the laser light indicia and reading assembly. The optical detector may be in communication with the computing system and the computing system may process the laser beam information to determine measurements and other setting information. In alternate embodiments the reflected laser beam may be received by one or several optical detector(s) remotely located with respect to the laser apparatus or the laser light indicia and reading assembly, but in communication with the computing system. As stated above the optical detector will relay the information gathered from the laser beam to the computing system where it may be processed and displayed to a user as measurement of setting information. For example, an optically reflective material may be circumferentially disposed about a circular saw blade of a table saw. The table saw may be disposed with a fence that has a laser apparatus (as described in FIG. 1) mounted upon it. The laser apparatus may emit one or more incident laser beams which strike the optically reflective material on the circular saw blade and, if the circular saw blade is perpendicular to the incident laser beams, are reflected back towards the laser apparatus. The laser apparatus may be disposed with one or more optical detectors to receive the reflected laser beam(s) and communicate the information gathered to the computing system for processing and display to a user. The type and configuration of the optically reflective material may vary as contemplated by one of ordinary skill in the art.

It is further contemplated that the laser apparatus or the laser light indicia and reading assembly may establish a communicative link with their respective computing systems through a communication system disposed within the device, to which the laser apparatus or the laser light indicia and reading assembly are mounted, itself. In this manner a mounting assembly as shown in FIGS. 6, 7, and 14 would not be necessary and the laser apparatus or the laser light indicia and reading assembly may be directly mounted to the device. Additionally, the laser apparatus or the laser light indicia and reading assembly may be enabled to accept power from the device to which they are mounted, thus, reducing the need to have a separate power source or power source connection. For example, a fence mounted to a table saw system may be disposed to connect with the laser apparatus or the laser light indicia and reading assembly. The fence may include a communication port, as shown and described on the mounting assemblies of FIGS. 7 and 14, which couples with a communication adapter disposed on the housing of the laser apparatus or the laser light indicia and reading assembly. The fence may further include a communication adapter which may be coupled with the computing system, thereby enabling the computing system to be in communication with the laser apparatus or the laser light indicia and reading assembly. Further, the power source for the table saw system may include an outlet on the fence which may be engaged by the laser apparatus or the laser light indicia and reading assembly to provide power to either system.

Heat build-up within the laser apparatus or the laser light indicia and reading assembly is an important concern. Overheating may result in malfunctioning of the laser source(s) within the housing and cause damage to the laser source or housing necessitating expensive repair and lost time. In one embodiment of the present invention the laser source may be a low power and low intensity laser source to minimize the heat build up with the housing. Such an embodiment is suitable for situations where the use of the laser apparatus and the laser light indicia and reading assembly is sporadic and limited. However, in a situation where the laser apparatus or the laser light indicia and reading assembly are in constant use over prolonged periods of time even a low power and intensity laser source may experience significant heat build up which may damage the system.

To effectively handle a situation where the heat build up is significant, the laser apparatus and the laser light indicia and reading assembly may include a cooling system. In one embodiment, the housing of either system may include vents to allow heat to escape and cooler air to be drawn into the housing to help cool the laser sources. In an alternate embodiment, the cooling system may be comprised of a fan assembly mounted within the housing to blow air through the housing and over the laser source(s). The housing may include a vent located at an end opposite the fan to allow the blown air and heat to escape. In a third embodiment a cooling system may comprise an inert coolant being run through the housing of the laser apparatus or the laser light indicia and reading assembly. The coolant system may include a tank of the inert coolant connected to the housing through tubing and then an exhaust system connected to the housing for removing and disposing of the inert coolant after it has run through the housing. It is contemplated that a coolant system may be disposed within a device to which the laser apparatus and the laser light indicia and reading assembly are connected. The inert coolant may be presented and exhausted through the mounting connection between the device and the laser apparatus or the laser light indicia and reading assembly. For example, the laser apparatus of FIG. 1, may include connection portals in the mounting members. When the mounting members are secured to a fence, such as shown in FIGS. 8 through 10, tubing, which is connected to a tank of the inert coolant, may be connected to one of the mounting members. The inert coolant may be pumped into the housing through the mounting member and then exhausted through the other mounting member. It is contemplated that a variety of coolant systems, as may be contemplated by one of ordinary skill in the art, may be employed without departing from the scope and spirit of the present invention.

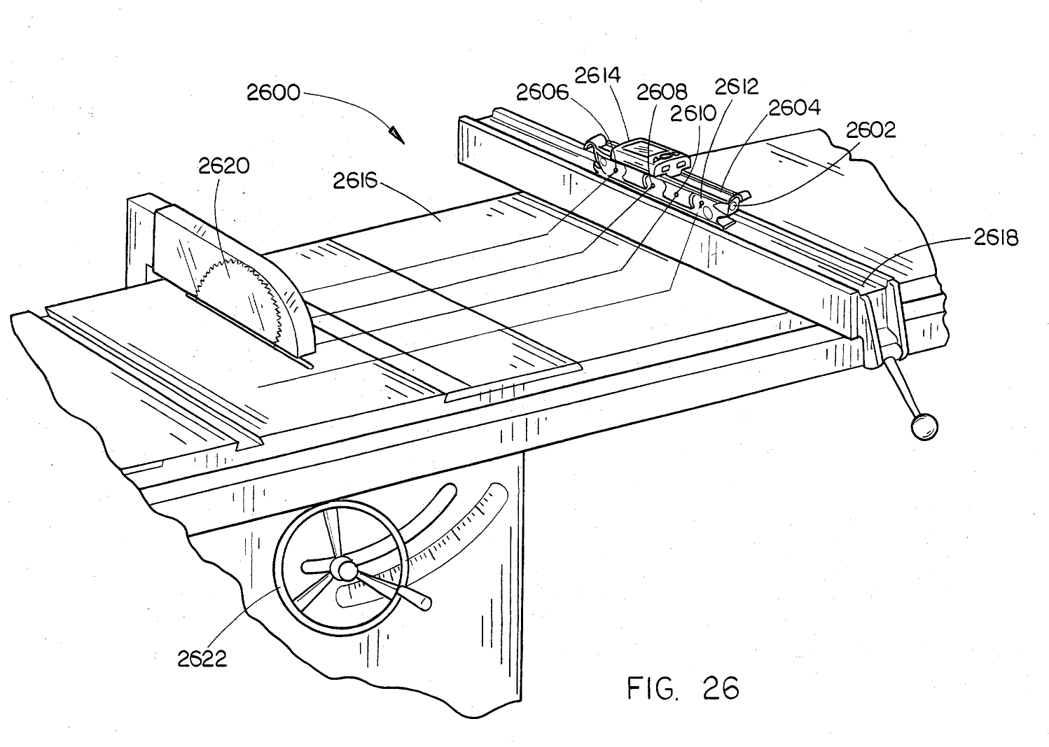

Referring now to FIG. 26 a table saw system 2600 including a laser apparatus 2602, is shown. The table saw system 2600 further includes a work surface 2616, a fence 2618, a circular saw blade 2620, and an adjustment mechanism 2622. The laser apparatus 2602 is similar to the laser apparatus of FIG. 1 with a housing 2604 and a computing system 2614. However, the laser apparatus 2602 includes four laser sources 2606, 2608, 2610, and 2612 disposed within the housing 2604 and each laser source includes a dithering assembly. In the present embodiment, the laser sources establish multiple laser beam lines across the operational field of the table saw system 2600. The laser beams provide information on distance of the fence 2618 from the circular saw blade 2620, the angle of the circular saw blade 2620 relative to the work surface 2616, and have the ability to sense when a work piece has entered the operational field of the table saw system 2600. It is understood that the laser apparatus 2602 may gather a variety of other information as discussed in FIGS. 1 through 12, without departing from the scope and spirit of the present invention.

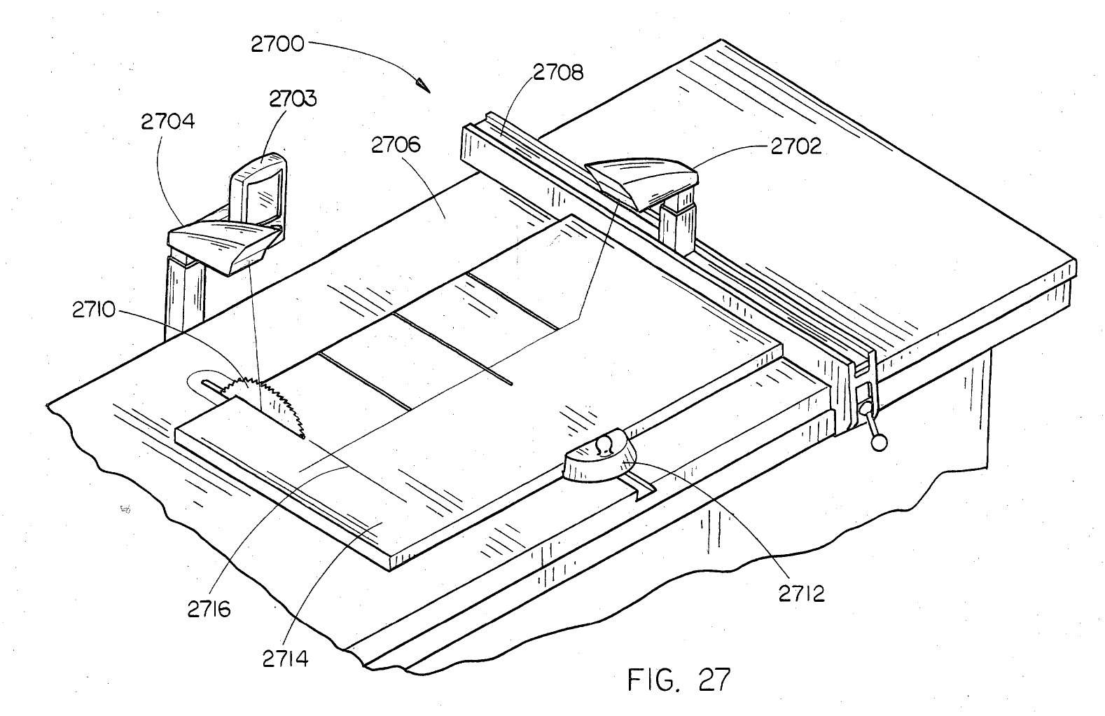

Referring now to FIG. 27, a table saw system 2700 including a first laser light indicia and reading assembly 2702 and a second laser light indicia and reading assembly 2704, is shown. Both the first and the second laser light indicia and reading assemblies 2702 and 2704 are coupled to a computing system 2703. The computing system controls the functionality of both laser light indicia and reading assemblies. Alternatively, each laser light indicia and reading assembly may be coupled with a separate computing system. The table saw system 2700 further includes a work surface 2706, a fence 2708, a circular saw blade 2710, and an angle adjustment mechanism 2712. The angle adjustment mechanism is similar to that discussed in FIG. 21. In the present embodiment, the first and second laser light indicia and reading assemblies are similar to the laser light indicia and reading assembly shown and described in FIG. 13, except that each of the housings is disposed with a plurality of laser sources. The plurality of laser sources may be enabled as scanning modules or include dithering assemblies to produce a laser beam grid 2716 upon a work piece 2714. Alternately, the laser beam grid 2716 may be established upon a work surface 2706 of the table saw system 2700. Using the first and second laser light indicia and reading assemblies a user of the table saw system 2700 is enabled to establish multiple cut lines and grid points by intersecting the laser beam lines produced. The exact location of the grid points may be determined by the user and entered into the computing system which controls the laser light indicia and reading assemblies. It is contemplated that a single computing system may be enabled to control both laser light indicia and reading assemblies or that a separate and independent computing system may be used to control each laser light indicia and reading assembly. In an alternate embodiment the laser light indicia and reading assemblies may be disposed with a single laser source as described in FIG. 13.

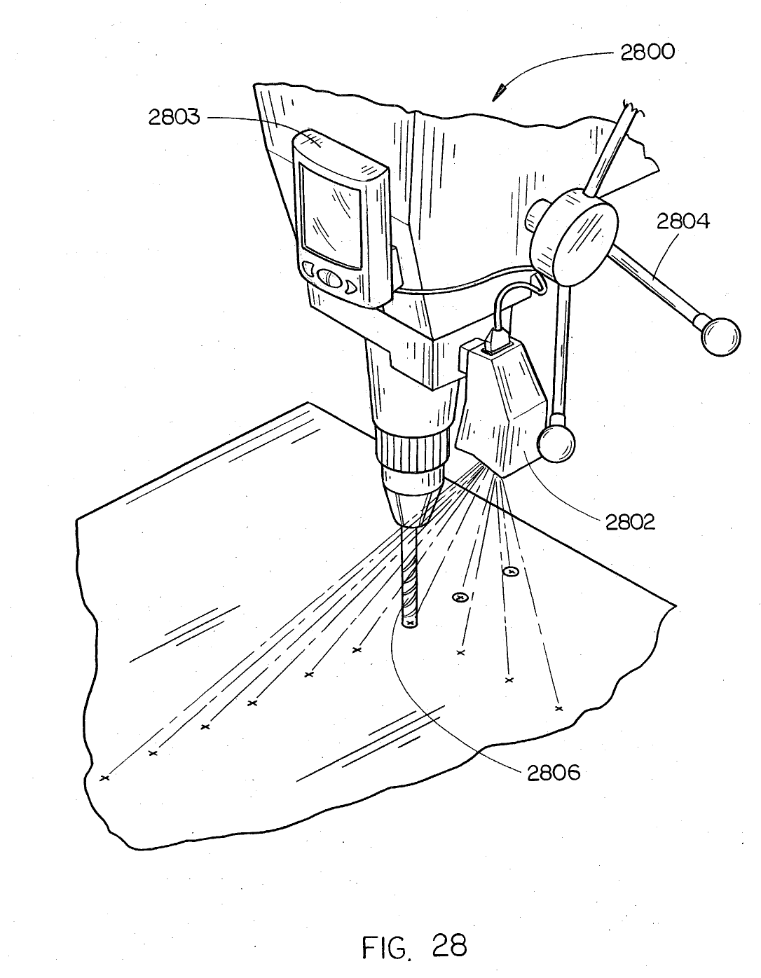

Referring now to FIG. 28, a drill press system 2800 including a laser light indicia and reading assembly 2802, is shown. The drill press system 2800 includes a housing 2803 disposed with an engagement device 2804 and a drill bit 2806. In the present embodiment, the laser light indicia and reading assembly 2802 is disposed with a laser source enabled to provide a plurality of drill points along two axes. This may be accomplished by a single laser source rotating identification points in series or multiple laser sources may be included within the laser light indicia and reading assembly 2802 to provide multiple identification points. Alternately, the laser light indicia and reading assembly 2802, with a single laser source, may establish a single continuous identification point. A computing system 2803 is coupled to the laser light indicia and reading assembly 2802 and mounted on the housing 2803. Alternatively, the computing system 2803 may be remotely located and couple with the laser light indicia and reading assembly 2802 via a wireless system.

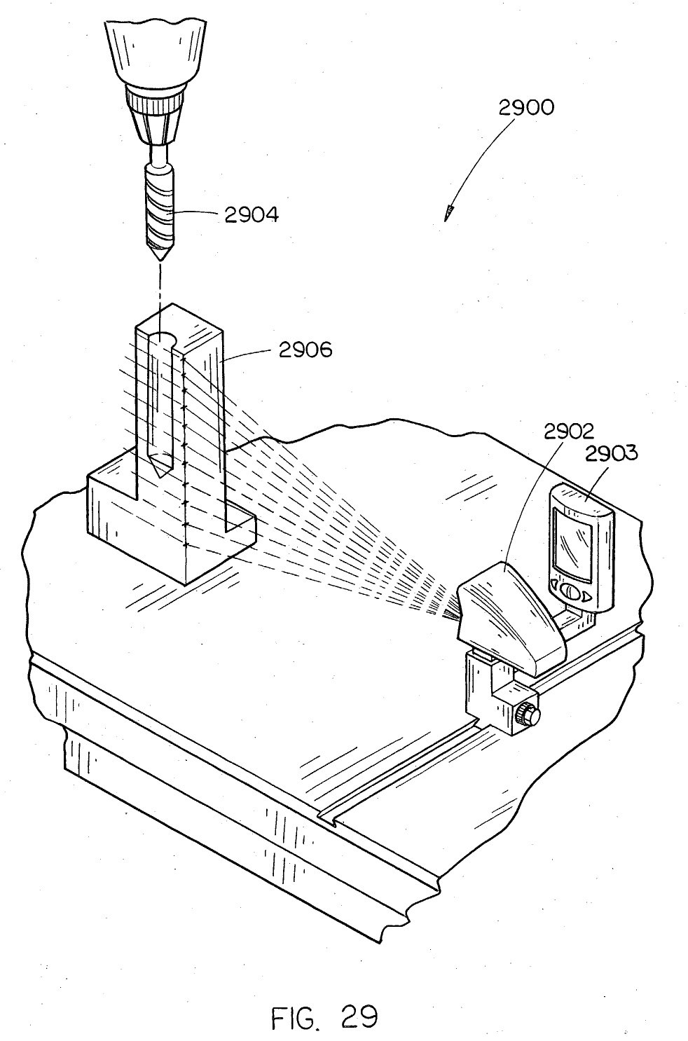

Referring now to FIG. 29, a laser light indicia and reading assembly 2902 included in a boring device system 2900, is shown. The laser light indicia and reading assembly 2902 is coupled to a computing system 2903 and may establish one or a plurality of depth indication points. This may be accomplished by a single laser source rotating identification points in series or multiple laser sources may be included within the laser light indicia and reading assembly 2902 to provide multiple identification points. As the boring bit 2904 proceeds through the work piece 2906 the laser light indicia and reading assembly is enabled to monitor the progress. When the boring bit 2904 reaches the desired depth the laser light indicia and reading assembly will provide an indication to the user of the boring device system 2900. As discussed previously, the indication may be provided through light emitting diodes, or the like.

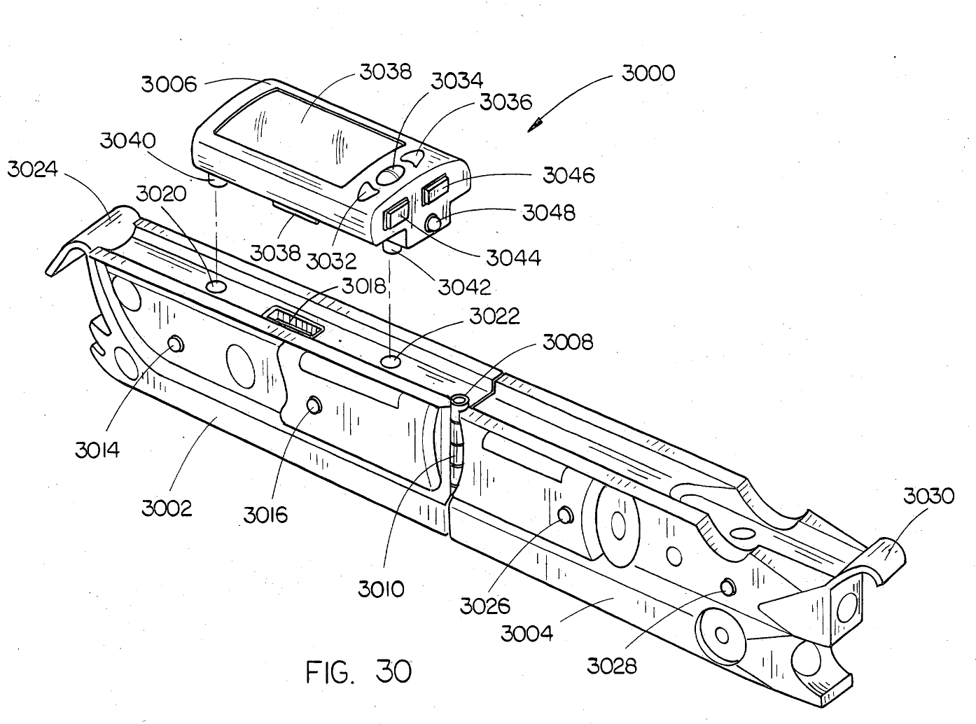

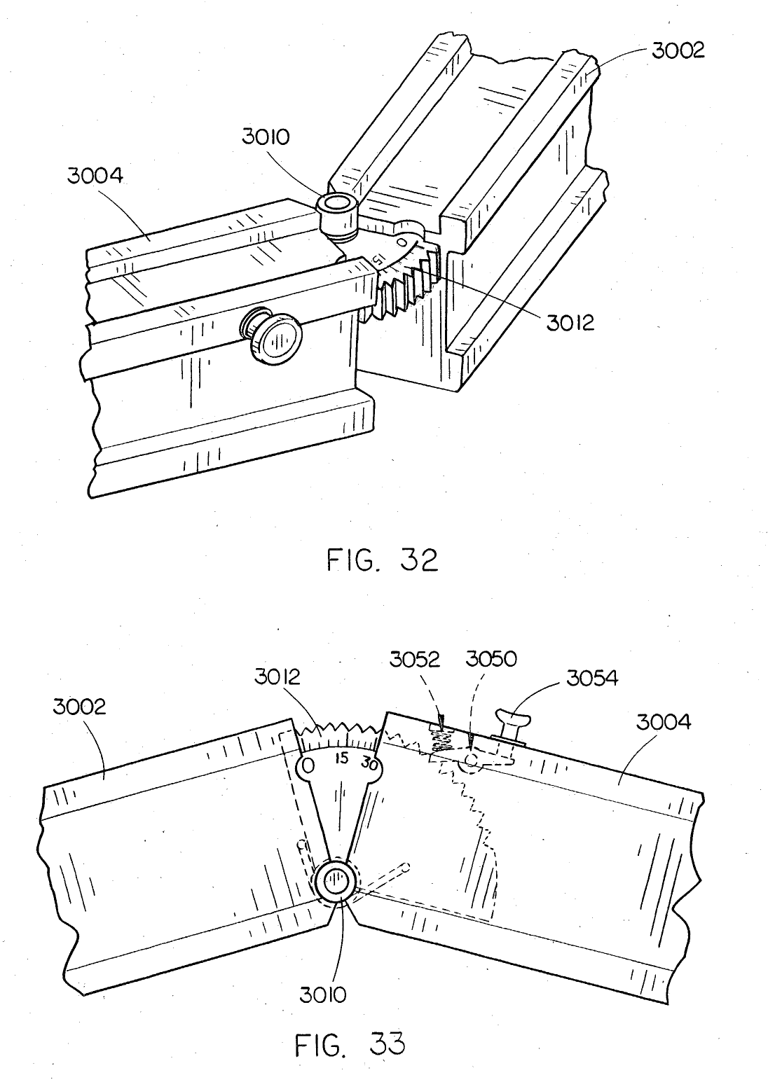

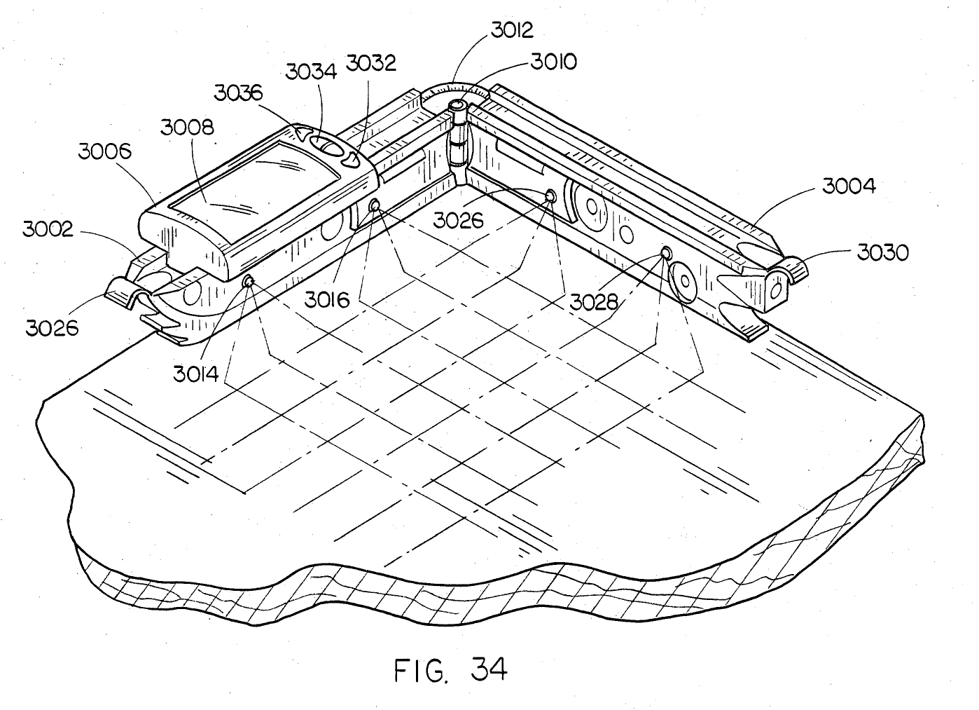

A rotating laser apparatus 3000 including a first housing member 3002, a second housing member 3004, and a computing system 3006 is shown in FIGS. 30 through 37. The first housing member 3002 includes a first laser source 3014, a second laser source 3016, a communication port 3018, a first coupling port 3020, a second coupling port 3022, and a grip 3024. The first housing member may include a mounting member, a latch, and a release mechanism as described previously in FIG. 1. The second housing member 3004 includes a third laser source 3026, a fourth laser source 3028, and a grip 3030. The second housing member 3004 may also include a mounting member, a latch, and a release mechanism as described previously in FIG. 1. The communication port 3018 provides communicative linkage to all four laser sources disposed within the first and the second housing members.

In the current embodiment, the computing system 3006 is coupled with the first housing member 3002. The computing system 3006 is similar to the computing system 104 described previously. The computing system includes a first selector 3032, a second selector 3034, and a third selector 3036. Further, a display screen 3038 provides an interactive medium for a user who is operating the rotating laser apparatus 3000. Additionally, the computing system 3006 includes a communication adapter 3038 for coupling with the communication port 3018 disposed on the first housing member 3002. The computing system also includes a first mounting member 3040 and a second mounting member 3042 for engaging with the first and second coupling ports 3020 and 3022 disposed on the first housing member 3002. A first button 3044 and a second button 3046 operably engage with the first and second mounting members to perform a latch and release function enabling a user to secure the computing system 3006 to the first housing member 3002 and remove the computing system 3006 from the first housing member 3002. An indicator 3048 is included on the computing system 3006 to provide a user feedback on whether the computing system 3006 is in communication with the four laser sources.

The two housing members 3002 and 3004 are coupled by a rotation mechanism 3008. The rotation mechanism 3008 comprises a joint 3010 coupled with an angle measurement device 3012. The angle measurement device 3012 includes teeth along the outer edge, away from the joint 3010. The teeth of the angle measurement device are engaged by a ratchet arm 3050 coupled on one end with a coiled compression spring mechanism 3052 and an activation mechanism 3054 on the other end. In the present embodiment, the ratchet arm 3050 and the coiled compression spring mechanism 3052 are disposed on the inside of the second housing member 3004 in a position proximal to the angle measurement device 3012. The activation mechanism 3054 extends through the second housing member 3004 allowing the user to depress an activation push button and adjust the angle of the second housing member 3004 relative to the first housing member 3002.

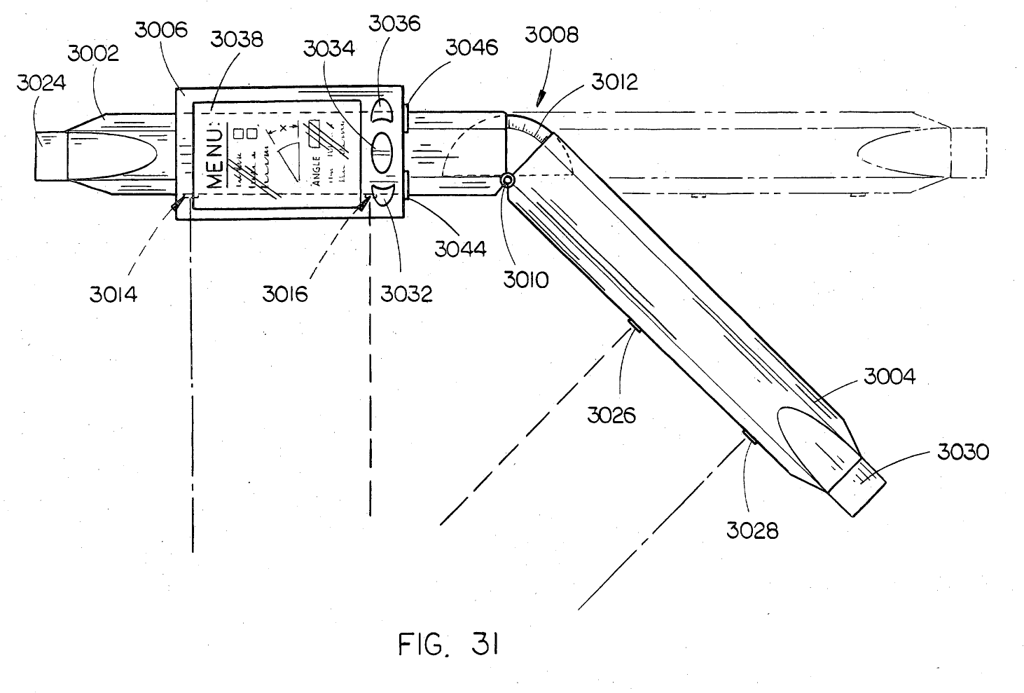

Preferably, joint 3010 is a hinge that allows the first and second housing members to be rotated along two axes, as shown in FIGS. 31 through 35. It is understood that the joint 3010 may be a variety of devices which enable such functionality as may be contemplated by one of ordinary skill in the art. Further, the angle measurement device 3012 indicates to a user of the rotating laser apparatus 3000 the degree that the first housing member 3002 is relative to the second housing member 3004. The position of the angle measurement device 3012 is fixed relative to the first housing member 3002. The fixed positioning of the angle measurement device 3012 may be accomplished by coupling the angle measurement device 3012 to the first housing member 3002, the joint 3010, or other methods as may be contemplated by one of ordinary skill in the art. The second housing member 3004 is allowed to slide freely over the angle measurement device 3012 as it is rotated relative to the first housing member 3002.

Alternatively, the rotation mechanism may be comprised of a variety of systems, such as a hydraulic system, compression system, or the like. Further, the user engagement device (i.e., the activation push button of the exemplary embodiment) may be other mechanisms as contemplated by one of ordinary skill in the art. Additionally, the rotation mechanism may be engaged directly by the user, as described above, or the rotation mechanism may be in communication with the computing system and the user may enter the desired angle and the rotation mechanism may set the rotating laser apparatus 3000 in the desired position.

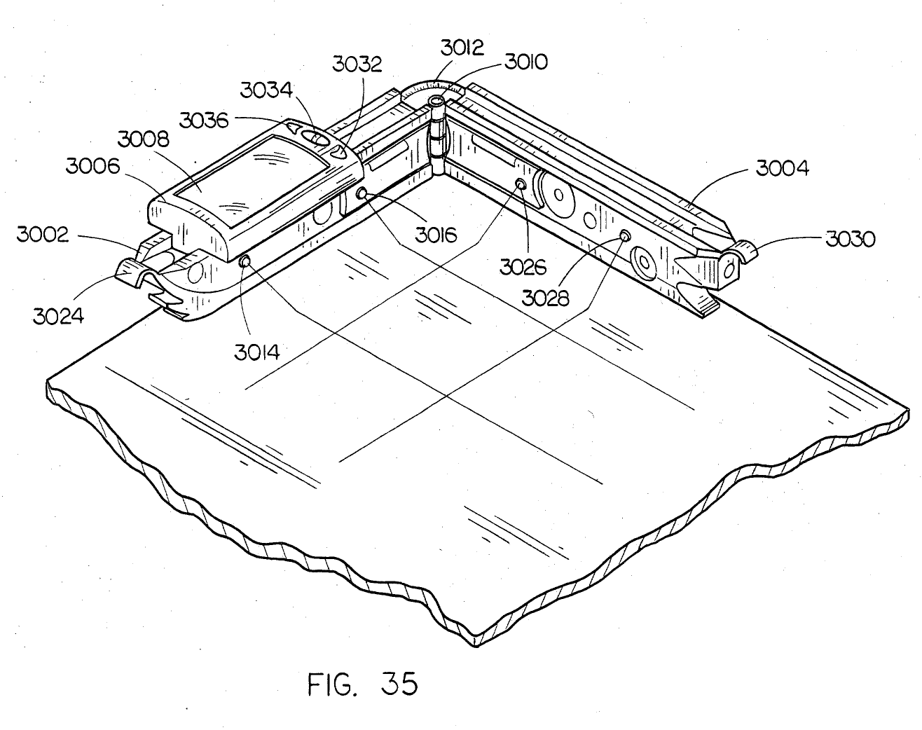

In the present embodiment, each of the two housing members include two laser sources. The first housing member 3002 includes a first laser source 3014 and a second laser source 3016. The second housing member 3004 includes a third laser source 3026 and a fourth laser source 3028. As shown in FIG. 35, the laser sources 3014, 3016, 3026, and 3028 may form a virtual grid allowing the user to specify a particular location for the execution of a function. Alternatively, the rotating laser apparatus 3000 may include a fewer or greater number of laser sources disposed within each of the housing members.

As discussed above, the computing system 3006 is similar to the computing system described previously in FIGS. 1 through 29. In the present embodiment, the computing system 3006 is in communication with the laser sources 3014, 3016, 3026, and 3028, and mounts upon the first housing member 3002. It is contemplated that the coupling of the computing system 3006 may occur upon the second housing member 3004. Exemplary interactive displays, readable on the computing system 2405, are shown in FIGS. 31, 36 and 37. The interactive displays may provide the user a display of the status of the laser source(s), the angle between the first and second housing members, the type of pattern to established, and gather information from the laser beams. Further, when the computing system 3006 is in communication with the rotation mechanism 3008 an interactive display on the computing system 3006 may allow the user to enter the desired angle and have the rotation mechanism set to that angle.

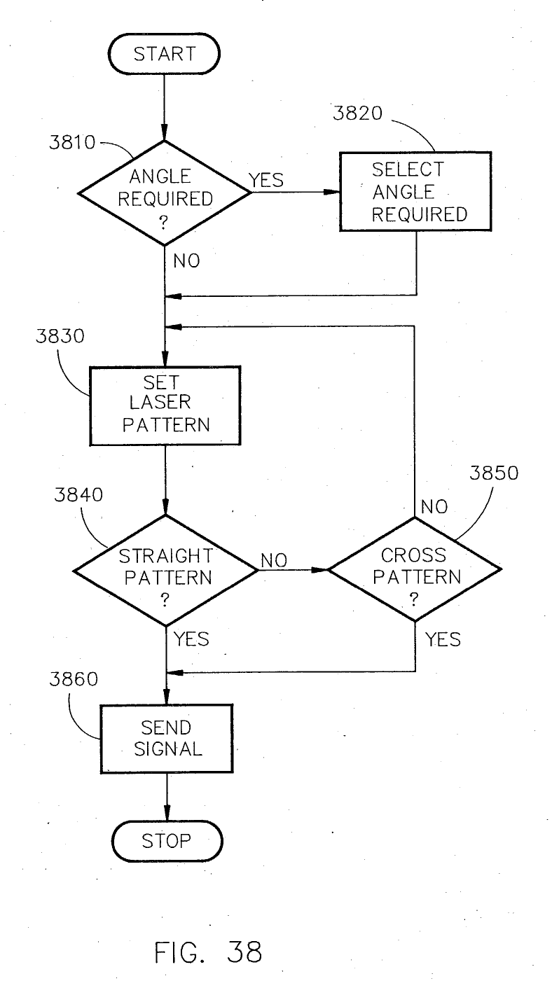

Referring now to FIG. 38, a flowchart illustrating the functional steps achieved using the interactive display of the computing system 3006 of the rotating laser apparatus 3000, is shown. In step 3810 the interactive display 3008 of the computing system 3006 asks the user to specify if an angle is required for the current assignment. The angle referred to is the angle that the first housing member 3002 is at relative to the second housing member 3004. If the user responds in the affirmative to this query then the user is asked to specify the angle required in step 3820. After the angle has been specified or if no angle is required for the current assignment, as directed by the user inputting the information through the interactive display 3008 of the computing system 3006, then in step 3830 the laser pattern is established.

Establishing the laser pattern occurs by the user being asked on the interactive display to specify the laser pattern required. In step 3840 the user is asked if the laser pattern is a straight laser pattern. If the user responds affirmatively, indicating that a straight laser pattern is to be established, then in step 3860 the laser signal is sent to establish the straight pattern. If in step 3840 a user indicates that a straight pattern is not desired then the user is asked, in step 3850, if a cross pattern is to be established. If the user responds to this query by indicating that a cross pattern is not to be established then the computing system 3006 returns to step 3830 and the interactive display prompts the user that the laser pattern setting must be established. It is contemplated that the computing system 3006, through the interactive display 3008, may allow for the user to manually enter a laser pattern to be established. If the user responds to the query of step 3850 in the affirmative, indicating that a cross pattern is to be established, then in step 3860 the laser signal is sent to establish the cross pattern.

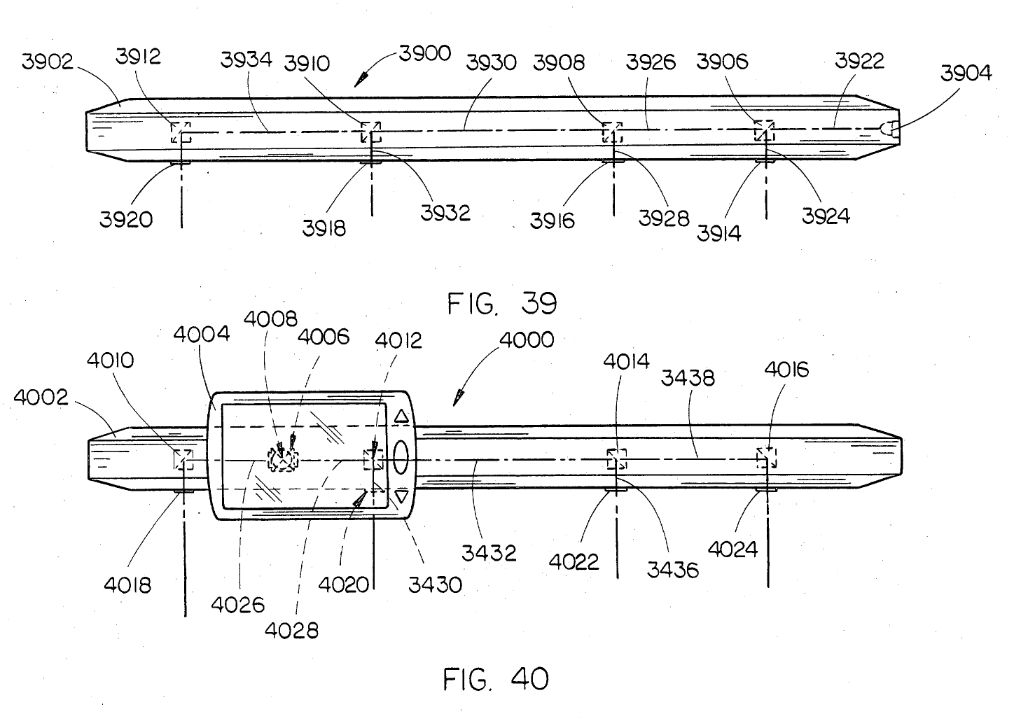

Referring now to FIG. 39, a laser apparatus 3900, is shown. In the current embodiment, the laser apparatus 3900 comprises a housing 3902 and a laser source 3904 coupled with the housing 3902. The housing 3902 further includes a first optical splitter 3906, a second optical splitter 3908, and a third optical splitter 3910. Further, the housing includes a first optical reflector 3912. Each of the optical splitters and the optical reflector is disposed within the housing 3902 in proximal location to a first emitter 3914, a second emitter 3916, a third emitter 3918, and a fourth emitter 3920, respectively.

The optical splitters function to split an incident laser beam received into two or more refracted laser beams. For example, in FIG. 39, an incident laser beam 3922 from the laser source 3904 strikes the first optical splitter 3906 whereupon the incident laser beam is divided into a first laser beam 3924 and a second laser beam 3926. The first laser beam 3924 is directed to the first emitter 3314 where it is emitted from the housing across an operational field. The operational field may be a variety of work area, such as those found on a table saw, drill press, belt sander, lathe, or the like. The second refracted laser beam 3926 is directed towards the second optical splitter 3908. In effect, the second laser beam 3926 is the incident laser beam for the second optical splitter 3908 whereupon striking the second optical splitter the second refracted laser beam is divided into a third laser beam 3928 and a fourth laser beam 3930. The third laser beam 3928 is directed to the second emitter 3916 where it is emitted form the housing across the operational field. The fourth laser beam 3930 becomes the incident laser beam for the third optical splitter 3910. The third optical splitter 3910 divides the laser beam into a fifth laser beam 3932 and a sixth laser beam 3934. The fifth laser beam 3932 is directed to the third emitter 3918 where it is emitted from the housing across the operational field. The sixth laser beam 3934 becomes the incident laser beam for the first optical reflector 3912. The first optical reflector 3912 directs the laser beam to the fourth emitter 3920 where it is emitted from the housing across the operational field.

A single laser source may reduce the power consumption of the current invention and provide a more effective way to deal with heat build up, which is inherent within a laser beam generating source. In an alternate embodiment the laser source may be a modular laser source capable of being inserted and removed from the housing of the laser apparatus. This may increase operational safety and provide an easier method of caring for the laser source by being able to remove it and store it in a separate location. Additionally, a variety of laser sources may be enabled to couple with the housing of the laser apparatus of the current invention. Thus, the user of the laser apparatus with a modular laser source has the capability of inserting the appropriate laser source for the job to be accomplished. For example, the user may need a simple laser source for one job and then require a laser source with a dithering assembly for another job. Additionally, the user may require a smaller output laser source in one situation and a larger output laser source in another. The needed functionality required by the user may be easily enabled with multiple modular laser sources with differing functional capabilities.

Referring now to FIG. 40, a laser apparatus 4000 is shown. In the present embodiment the laser apparatus 4000 comprises a housing 4002 coupled with a computing system 4004. Preferably, the computing system 4004 is similar to the computing systems described previously, except that in the present embodiment the computing system 4004 includes a laser source 4006. The housing includes a first optical splitter 4008, a first optical reflector 4010, a second optical splitter 4012, a third optical splitter 4014, and a second optical reflector 4016. The housing further includes a first emitter 4018, a second emitter 4020, a third emitter 4022, and a fourth emitter 4024.

The laser source 4006 emits an incident laser beam into the housing 4002 which is then split by a first optical splitter 4008 into a first laser beam 4026 and a second laser beam 4028. The first laser beam 4026 is directed to the first optical reflector 4010 where it is reflected through the first optical emitter 4018 and emitted across an operational field. The second laser beam 4028 is directed to the second optical splitter 4008 which divides the second laser beam into a third laser beam 4030 and a fourth laser beam 4032. The third laser beam 4030 is directed through the second emitter 4020 across the operational field and the fourth laser beam 4032 becomes the incident laser beam for the third optical splitter 4012. The third optical splitter 4010 divides the fourth laser beam 4032 into a fifth laser beam 4034 and a sixth laser beam 4036. The fifth laser beam 4034 is directed through the third emitter 4022 across the operation field and the sixth laser beam 4036 becomes the incident laser beam for the second optical reflector 4014. Upon striking the second optical reflector 4014, the sixth laser beam 4036 is reflected through the fourth optical emitter 4024 and emitted across the operational field.

In an additional embodiment, the laser apparatus may include an optical splitter control mechanism. This mechanism may allow a user to determine the number of laser beams emitted from the housing of the laser apparatus. This may be beneficial when the laser apparatus is being used in situations where the size of the work surface and other components are constantly changing. For example, on a table saw all four emitters may need to be engaged to cover the work surface presented. However, a drill press may have a much smaller working surface and using more than two emitters may not be beneficial to gathering the needed information as they may be outside the scope of the work surface available.

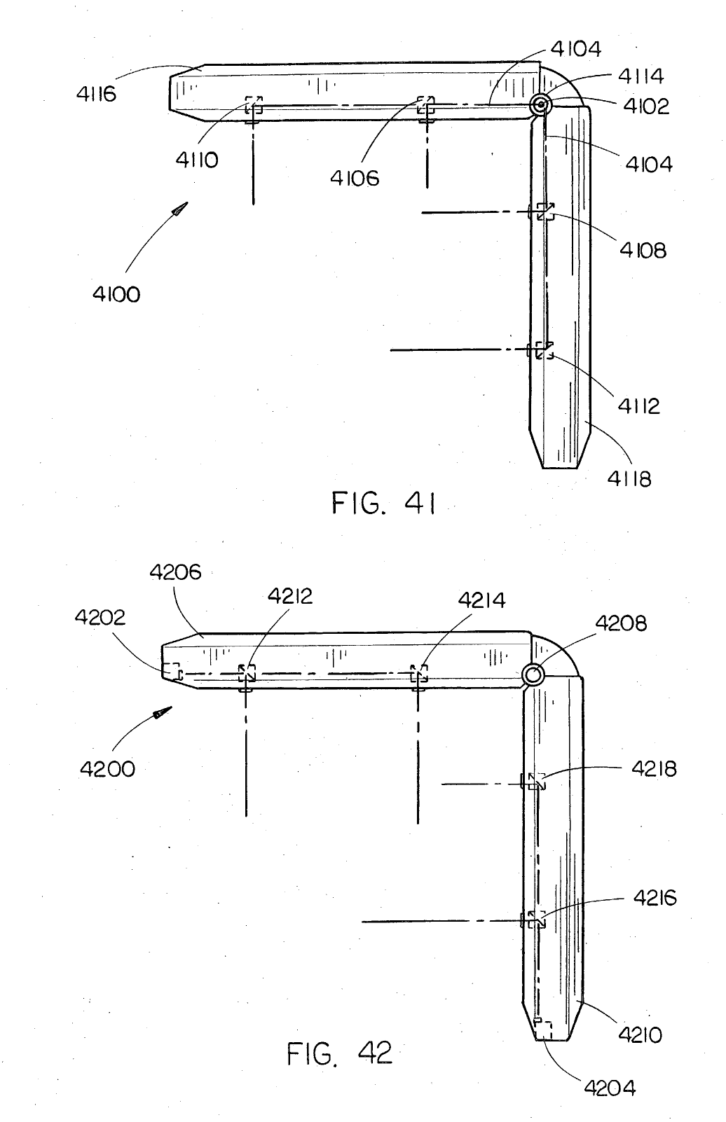

Referring now to FIG. 41, a rotation laser apparatus 4100 including a single laser source 4102, is shown. The single laser source 4102 emits an incident laser beam 4104 which is split by a first optical splitter 4106 and a second optical splitter 4108. The laser beam is also reflected by a first optical reflector 4110 and a second optical reflector 4112. The optical splitters and reflectors function in the same manner as described previously in FIGS. 39 and 40. In the present embodiment the single laser source 4102 is located within the joint 4114 connecting a first housing member 4116 to a second housing member 4118. Power may be provided through a portable power source or a power cord as described in previous figures.

A rotation laser apparatus 4200 including a first laser source 4202 and a second laser source 4204, is shown in FIG. 39. In the present embodiment a first housing member 3606 is disposed on one end with the first laser source 3602 and connected at the opposite end, through joint 3608, to a second housing member 3610. The second housing member 3610 is disposed on the opposite end of its connection to the joint 3608 with the second laser source 3604. The first housing member 3606 further includes a first optical splitter 3612 and a first optical reflector 3614. The second housing member 3610 further includes a second optical splitter 4216 and a second optical reflector 4218. The operation of the splitters and reflectors is similar to that previously described in FIGS. 39 and 40.

In both FIGS. 41 and 42 the number and configuration of optical splitters and reflectors may vary as contemplated by one of ordinary skill in the art. It is understood that the laser sources shown in the present embodiments are exemplary and may not be read as limiting or exclusive. As discussed in FIGS. 39 and 40 the laser apparati of FIGS. 41 and 42 may includes photo multipliers of various configurations in order to provide additional functionality to the laser apparatus. Alternatively, the laser sources provided in FIGS. 41 and 42 may be modular. The laser sources may be removed from the joint or the housing members and replaced with alternate laser sources.

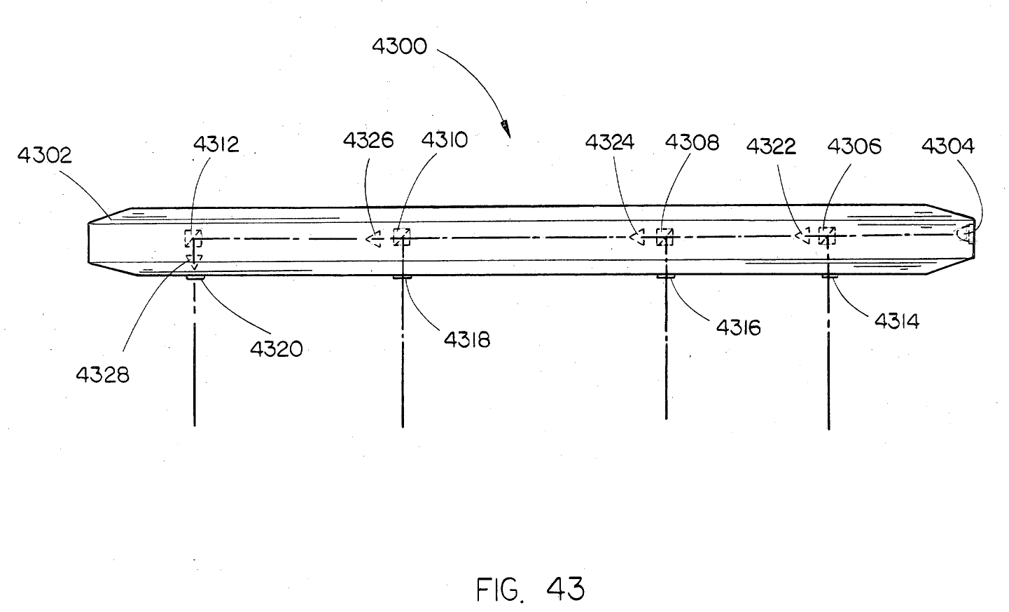

Referring now to FIG. 43, a laser apparatus 4300 is shown. The laser apparatus 4300 comprises a housing 4302 disposed with a laser source 4304. The housing is further disposed with a first optical splitter 4306, a second optical splitter 4308, a third optical splitter 4310, and an optical reflector 4312. The functionality of the optical splitters and the optical reflector is similar to that described in FIGS. 39 through 42. Additionally, the housing includes a first emitter 4314, a second emitter 4316, a third emitter 4318 and a fourth emitter 4320.

In the present embodiment, a plurality of light signal enhancing instruments 4322, 4324, 4326, and 4328. These light signal enhancing instruments may be photomultipliers comprising a variety of designs, such as photomultiplier end-on tubes, side-on photomultipliers, or the like. The photomultipliers may accept an incident laser beam and intensify the light signal by increasing the number of electrons in order to maintain sufficient light signal strength as the laser beam is being passed down from one optical splitter to the next. Further, the light signal enhancing instruments may be positioned in front of the emitters in order to provide optimum light signal output.

Alternatively, the light signal enhancing instruments may include a secondary laser source, such that the incident laser beam received has its signal strength increased. For example, a low power laser source may be included within the light signal enhancing instrument which contributes a second light signal to the existing laser beam in order to make up for a loss of light signal intensity. Such a system of multiple light signal enhancing instruments may decrease production costs by substituting low power laser sources for separate and independent laser sources located throughout the laser apparatus. It is understood that the configuration and numbers of light signal enhancing instruments may vary as contemplated by one of ordinary skill in the art.

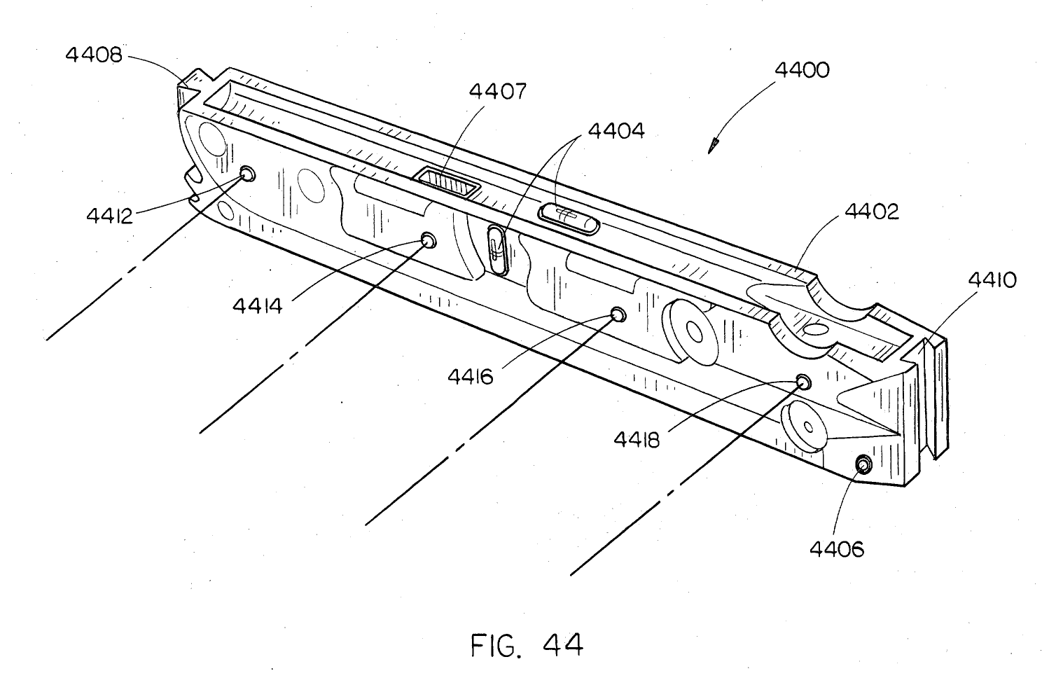

Referring now to FIGS. 44, 45, and 46, a laser apparatus 4400 is shown. In the current embodiment, the laser apparatus 4400 comprises a housing 4402 including a leveling mechanism 4404 and a wireless receiver 4406. The housing 4402 further includes a communication port 4407, an attachment adapter 4408, and an attachment receiver 4410. Additionally, the housing 4402 includes a first laser source 4412, a second laser source 4414, a third laser source 4416, and a fourth laser source 4418.

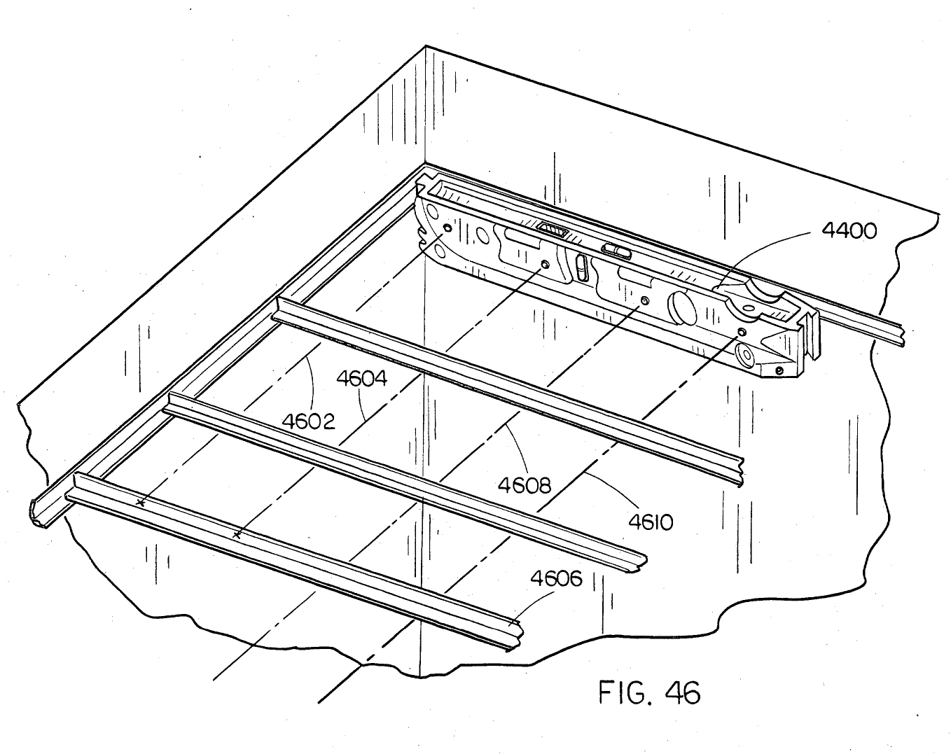

The leveling mechanism 4404 enables a user to determine the level characteristics of the laser apparatus 4400 in any location. Previous embodiments of the laser apparatus showed the leveling mechanism within the mounting assembly. By placing the leveling mechanism within the housing 4402, the user may establish accurate placements in locations such as on a wall for use in mounting a drop ceiling, as shown in FIG. 46.

The laser sources 4412 through 4418 are similar to the laser sources shown and described previously. It is contemplated that a laser source may be located to emit a laser beam from either end of the housing 4402. For example, a laser source may be positioned within the attachment adapter 4408. By placing the laser source at either end of the housing the laser apparatus 4400 may be enabled to determine the level characteristics of objects located along a flat surface to which the laser apparatus 4400 is mounted, such as a picture on a wall or the like.

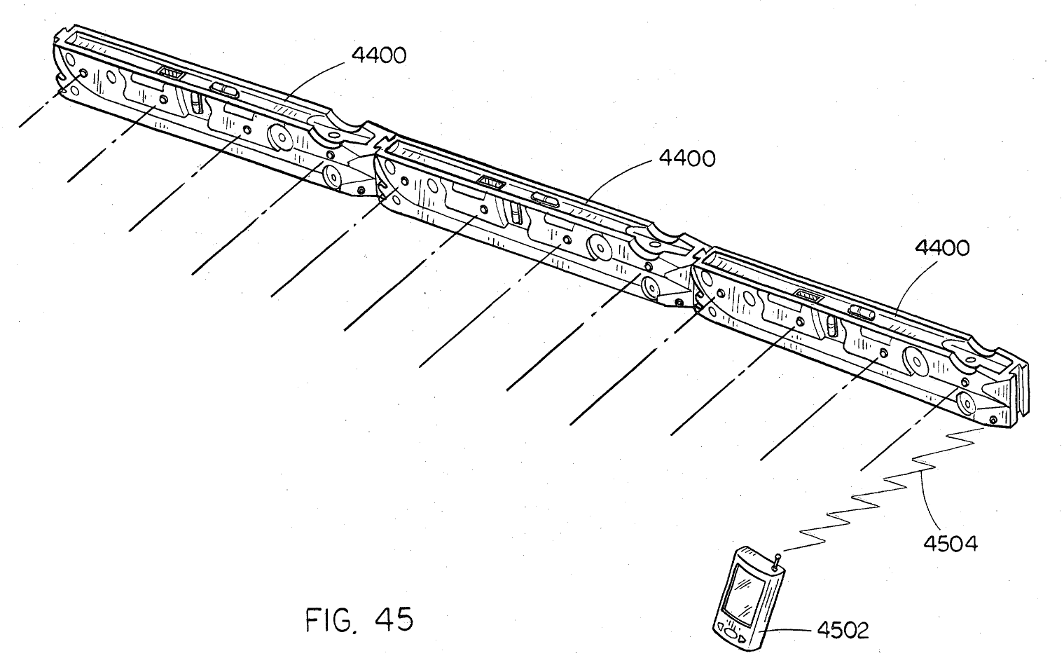

The wireless receiver 4406 enables communication between the laser apparatus 4400 and a computing device 4502, shown in FIG. 45. In alternate embodiments the computing system may be communicatively coupled to the laser apparatus using a variety of systems, such as serial cable, Bluetooth, Infrared, or the like. The wireless communication system allows a user to mount the laser apparatus 4400 in a remote location, such as that shown in FIG. 46, and receive information on the computing system 4502. For example, shown in FIG. 46, the laser apparatus 4400 is mounted to a wall to provide leveling information for a drop ceiling. A first laser beam 4602 and a second laser beam 4604 are shown striking a support rail 4606 for the drop ceiling. In this situation the laser apparatus may communicate to the computing system that the support rail 4606 is not level at the two identified points. A third laser beam 4608 and a fourth laser beam 4610 may provide no such indication that the support rail 4606 is out of level. Thus, a user is informed not only of the misalignment but also where along the support rail 4606 the misalignment is occurring.

The attachment adapter 4408 and the attachment receiver 4410 enable linking of one laser apparatus to another. As shown in FIG. 45, a plurality of laser apparatus 4400 may be connected. In this embodiment, the multiple laser apparatus are in communication with the computing system 4502. It is contemplated that the attachment adapter and attachment receiver provide a communicative link between each of the laser apparatus 4400 allowing a single computing system to control all connected laser apparatus. Alternately, each laser apparatus may receive the wireless signal 4504 being sent out by the computing system 4502.

It is understood the leveling mechanism 4404 may be disposed within any of the previous embodiments of the laser apparatus, shown in FIG. 1 or 30. It is further understood that the laser apparatus 4400 may include mounting members and latch and release mechanisms, such as those previously shown and described in FIG. 1. Additionally, a mounting assembly for connecting the laser apparatus 4400 to a wall or other vertical surface is contemplated. The communication port 4407 enables a computing system to communicate with the laser sources 4412 through 4418. The housing 4402 of the laser apparatus 4400 may be disposed with both the wireless receiver 4406 and the communication port 4407 or one or the other.

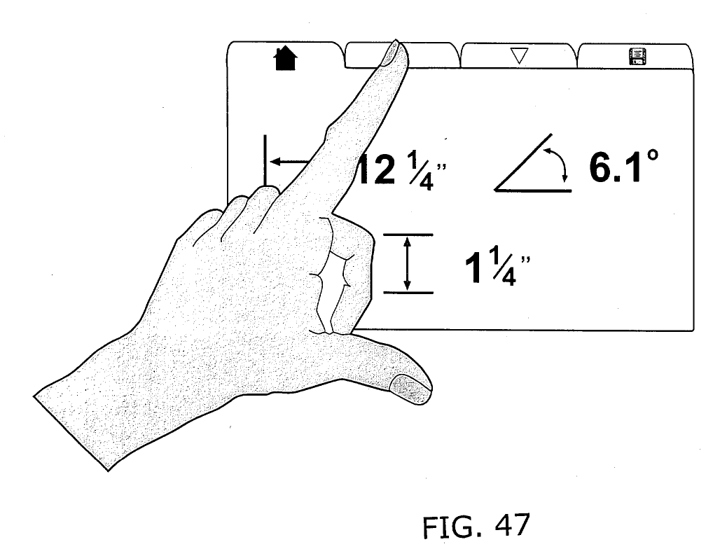

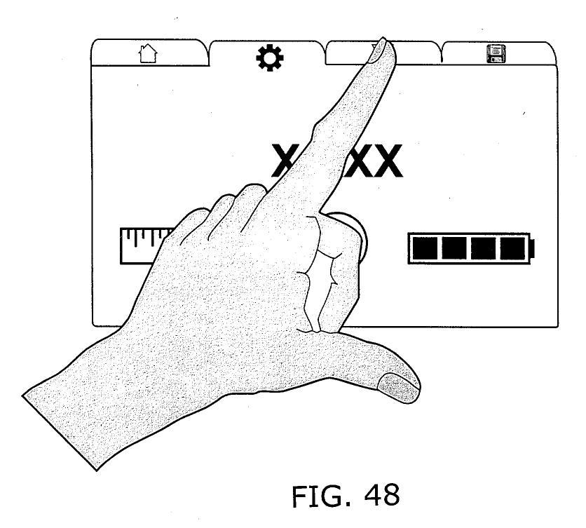

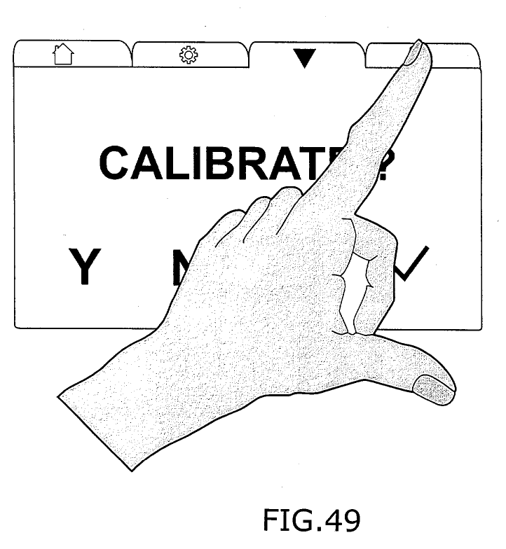

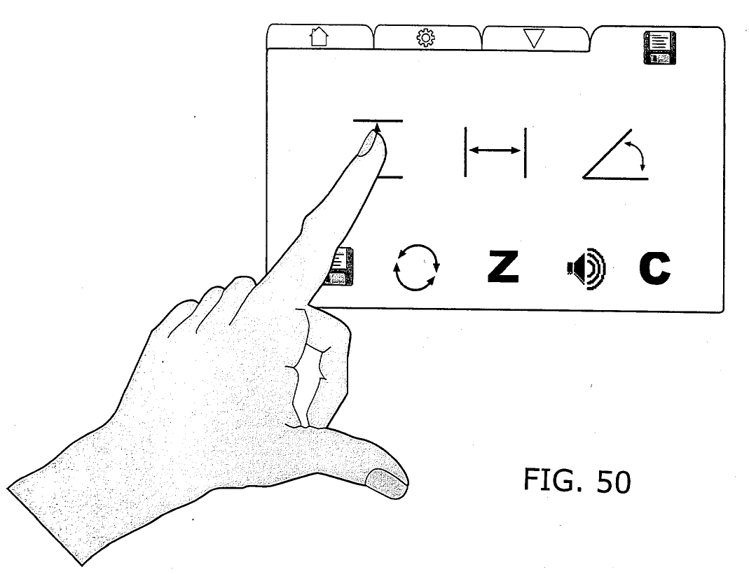

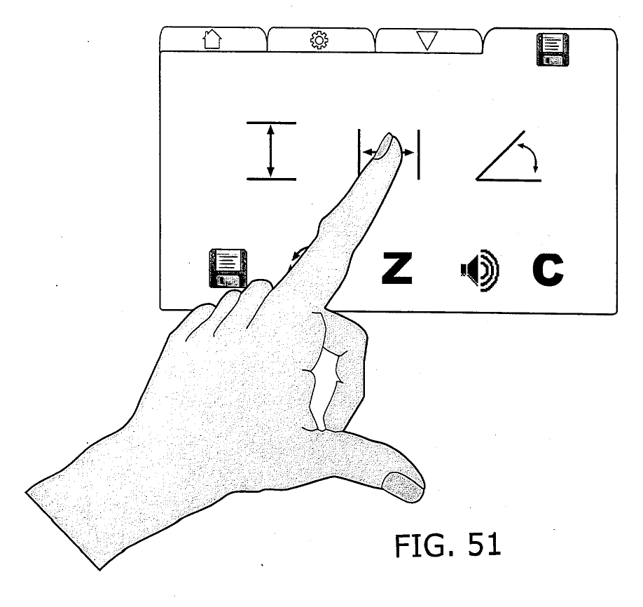

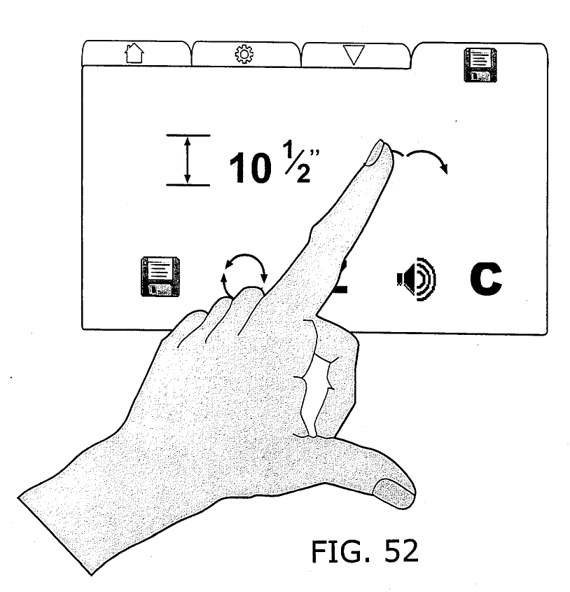

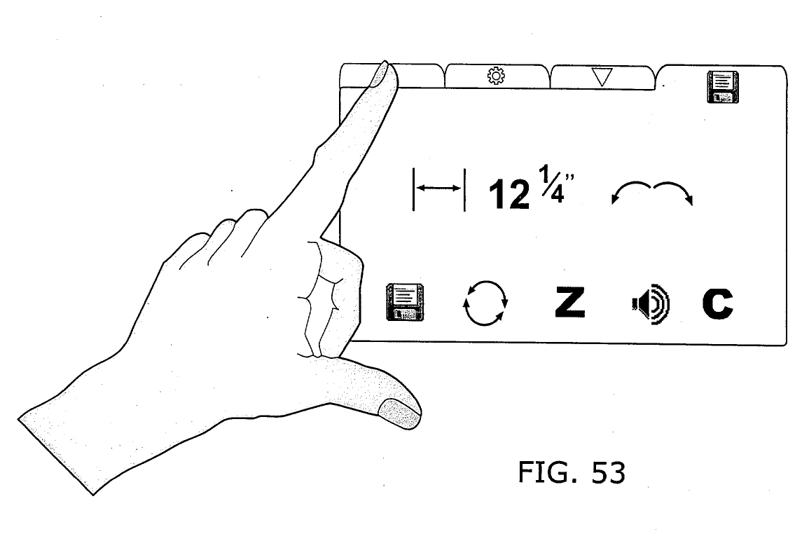

FIGS. 47 through 53 illustrate an exemplary graphical-user-interface for use with embodiments of the present invention, wherein (a) blade-to-fence distance; (b) blade bevel; and (c) blade height, are illustrated on a single interface screen.

The

In the exemplary embodiments, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the scope and spirit of the present invention. The accompanying method claims present elements of the various steps in a sample order, and are not necessarily meant to be limited to the specific order or hierarchy presented.

It is believed that the laser apparatus for use with power tools of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

1. A table saw, comprising:
a. a frame coupled with a table, said table having an aperture;
b. a trunion moveably and operatively connected to said frame, said trunion supporting a blade and drive assembly, said blade capable of being operatively extended from said table aperture, said blade being operatively tilted in at least one axis tangent to said table;
c. a fence moveably coupled with said table and generally moveable parallel to said blade;
d. a non-contact measurement and alignment device operative with said table saw, the non-contact measurement and alignment device for determining at least two of a table saw setting: (i) blade height, (ii) blade angle, and (iii) fence to blade distance; and
e. a graphical-user-interface communicatively coupled with the non-contact measurement and alignment device, the graphical-user-interface for user operation of said table saw for indicating at least two of a table saw setting: (i) blade height, (ii) blade angle, and (iii) fence to blade distance.

2. The table saw of claim 1, wherein said graphical-user-interface includes both text and graphics.

3. The table saw of claim 1, wherein said graphical-user-interface includes multiple pages.

4. The table saw of claim 1, wherein said multiple pages of said graphical-user-interface are logically related in related folders.

5. The table saw of claim 1, wherein said graphical-user-interface includes at least one page illustrating (i) blade height, (ii) blade angle, and (ii) fence to blade distance.

6. A non-contact measurement and alignment device, comprising:
a housing for connecting to a power tool; and
a laser source connected to the housing, the laser source for emitting at least two laser beams,
wherein the laser source by emitting the at least two laser beams determines at least two of a power tool settings.

7. The non-contact measurement and alignment device of claim 6, wherein the laser source emits at least one of a group consisting of at least three laser beams and at least four laser beams.

8. The non-contact measurement and alignment device of claim 6, wherein the housing is connected with at least one of a group consisting of at least two laser sources, at least three laser sources, and at least four laser sources.

9. The non-contact measurement and alignment device of claim 6, wherein the housing includes a cooling system.

10. The non-contact measurement and alignment device of claim 6, wherein the housing includes at least one mounting member.

11. The non-contact measurement and alignment device of claim 10, further comprising a mounting assembly for connecting with the mounting member.

12. The non-contact measurement and alignment device of claim 6, wherein the housing includes an optical splitter and an optical reflector.

13. The non-contact measurement and alignment device of claim 6, wherein the housing includes a light signal enhancing instrument.

14. The non-contact measurement and alignment device of claim 6, wherein the housing includes a leveling mechanism.

15. The non-contact measurement and alignment device of claim 6, wherein the laser source is a modular laser source.

16. The non-contact measurement and alignment device of claim 6, wherein the laser source is communicatively coupled with a graphical user interface.

17. A non-contact measurement and alignment device, comprising:
a housing including at least one mounting member;
a mounting assembly for connecting with the at least one mounting member, the mounting assembly for further connecting the non-contact measurement and alignment device with a power tool;
at least two laser sources connected with the housing, the at least two laser sources for emitting at least two laser beams,
wherein the at least two laser sources by emitting the at least two laser beams determine at least two settings of a power tool.

18. The non-contact measurement and alignment device of claim 17, wherein the at least two laser sources emit at least one of a group consisting of at least three laser beams and at least four laser beams.

19. The non-contact measurement and alignment device of claim 17, wherein the housing is connected with at least one of a group consisting of at least three laser sources and at least four laser sources.

20. The non-contact measurement and alignment device of claim 17, wherein the housing includes a cooling system.

21. (canceled)

22. (canceled)

23. The non-contact measurement and alignment device of claim 17, wherein the housing includes an optical splitter and an optical reflector.

24. The non-contact measurement and alignment device of claim 17, wherein the housing includes a light signal enhancing instrument.

25. The non-contact measurement and alignment device of claim 17, wherein the mounting assembly includes a leveling mechanism.

26. The non-contact measurement and alignment device of claim 17, wherein the at least two laser sources are modular laser sources.

27. The non-contact measurement and alignment device of claim 17, wherein the at least two laser sources are communicatively coupled with a graphical user interface.

28. A non-contact measurement and alignment device, comprising:
a housing including at least one mounting member;
a mounting assembly for connecting with the at least one mounting member, the mounting assembly for further connecting the non-contact measurement and alignment device with a power tool;
at least three laser sources connected with the housing, the at least three laser sources for emitting at least three laser beams,
wherein the at least three laser sources by emitting the at least three laser beams determine at least two settings of a power tool.

29. The non-contact measurement and alignment device of claim 28, wherein the housing includes a cooling system.

30. (canceled)

31. (canceled)

32. The non-contact measurement and alignment device of claim 28, wherein the housing includes an optical splitter and an optical reflector.

33. The non-contact measurement and alignment device of claim 28, wherein the housing includes a light signal enhancing instrument.

34. The non-contact measurement and alignment device of claim 28, wherein the mounting assembly includes a leveling mechanism.

35. The non-contact measurement and alignment device of claim 28, wherein the at least three laser sources are modular laser sources.

36. The non-contact measurement and alignment device of claim 28, wherein the at least three laser sources are communicatively coupled with a graphical user interface.

37. A non-contact measurement and alignment device, comprising:
a housing;
a mounting assembly for connecting with the housing, the mounting assembly for further connecting the non-contact measurement and alignment device with a power tool;
at least two laser sources connected with the housing, the at least two laser sources for emitting at least two laser beams for determining at least two settings of a powered cutting implement of the power tool,
wherein the at least two settings are selected from the group consisting of a powered cutting implement height, a powered cutting implement angle, and a distance of the powered cutting implement from the non-contact measurement and alignment device.

38. The non-contact measurement and alignment device of claim 37, wherein the power tool is selected from the group consisting of a table saw, a planer, a lathe, and a drill press.

39. The non-contact measurement and alignment device of claim 37, wherein the mounting assembly includes a leveling device for providing a visual indication to a user that the mounting assembly is in a level orientation with respect to the power tool to which the mounting assembly is mounted.

40. The non-contact measurement and alignment device of claim 37, wherein the housing includes at least one mounting member for coupling with the mounting assembly.

41. The non-contact measurement and alignment device of claim 37, wherein the housing includes a release mechanism for disconnecting the housing from the mounting assembly.

42. A non-contact measurement and alignment device, comprising:
a housing;
a mounting assembly for connecting with the housing, the mounting assembly for further connecting the non-contact measurement and alignment device with a power tool;
at least three laser sources connected with the housing, the at least three laser sources for emitting at least three laser beams for determining at least two settings of a powered cutting implement of the power tool,
wherein the at least two settings are selected from the group consisting of a powered cutting implement height, a powered cutting implement angle, and a distance of the powered cutting implement from the non-contact measurement and alignment device.

43. The non-contact measurement and alignment device of claim 42, wherein the power tool is selected from the group consisting of a table saw, a planer, a lathe, and a drill press.

44. The non-contact measurement and alignment device of claim 42, wherein the mounting assembly includes a leveling device for providing a visual indication to a user that the mounting assembly is in a level orientation with respect to the power tool to which the mounting assembly is mounted.

45. The non-contact measurement and alignment device of claim 42, wherein the housing includes at least one mounting member for coupling with the mounting assembly.

46. The non-contact measurement and alignment device of claim 42, wherein the housing includes a release mechanism for disconnecting the housing from the mounting assembly.
